(19) United States
(12) Patent Application Publication
(10) Pub. No.: US 2025/0106162 A1
(43) Pub. Date: Mar. 27, 2025

(54) METHODS AND APPARATUS FOR ACCESS TRAFFIC STEERING, SWITCHING, AND SPLITTING (ATSSS) REDUNDANT TRAFFIC STEERING MODE

(71) Applicant: INTERDIGITAL PATENT HOLDINGS, INC., Wilmington, DE (US)

(72) Inventors: Rocco Di Girolamo, Laval (CA); Michelle Perras, Montreal (CA); Guanzhou Wang, Brossard (CA); Saad Ahmad, Montreal (CA)

(73) Assignee: INTERDIGITAL PATENT HOLDINGS, INC., Wilmington, DE (US)

(21) Appl. No.: 18/833,213

(22) PCT Filed: Jan. 27, 2023
(86) PCT No.: PCT/US2023/011792

§ 371 Date: Jul. 25, 2024

Related U.S. Application Data
(60) Provisional application No. 63/303,722, filed on Jan. 27, 2022.
(60) Provisional application No. 63/411,546, filed on Sep. 29, 2022.

(51) Int. Cl. H04L 47/122; H04L 45/24; H04W 24/08

(52) U.S. Cl. CPC H04L 47/122; H04L 45/24; H04W 24/08

(57) ABSTRACT

Procedures, methods, etc., directed to access traffic steering, switching, and splitting redundant traffic steering mode are provided. A method may include transmitting, to a first network element, information indicating a request to establish/modify a multi-access protocol data unit (PDU) session; receiving, via a second network element, information indicating a response to the request to establish/modify a multi-access PDU session; determining first and second values of a plurality of metrics for first and second access networks (ANs); determining to transmit a PDU associated with the multi-access PDU session via a one of (i) the first AN, (ii) the second AN or (iii) the first and second ANs based on a rule and on the first and second values of the plurality of metrics satisfying respective conditions of the rule; and transmitting the PDU via the one of the first AN, the second AN or the first and second ANs.

### CROSS-REFERENCE TO RELATED APPLICATIONS

This application claims the benefit of U.S. Provisional Patent Application Nos. (i) 63/303,722 filed Jan. 27, 2022, and (ii) 63/411,546 filed Sep. 9, 2022; each of which is incorporated herein by reference.

### BACKGROUND

This disclosure relates to communications in connection with a plurality of accesses (also referred to as “access networks”) of one or more communications systems, including, but not exclusively, to methods, apparatuses, systems, etc. directed to access traffic steering, switching, and splitting (ATSSS) redundant traffic steering mode.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating a WTRU with simultaneous 3GPP and non-3GPP access in Release 15;

FIG. 3 is a block diagram illustrating a WTRU with simultaneous 3GPP and non-3GPP access in Release 16;

FIG. 4 is a flow diagram illustrating redundant steering mode operation according to an embodiment;

FIG. 5 is a signaling diagram illustrating enhanced packet data unit (PDU) session establishment to support redundant steering mode according to an embodiment;

FIG. 6 is a signaling diagram illustrating WTRU notification of change in a state of redundant steering mode;

FIG. 7 is a flow chart illustrating an example flow for use in connection with a multi-access PDU session establishment and/or multi-access PDU session modification;

FIG. 8 is a flow chart illustrating an example flow according to various embodiments;

FIG. 9 is a flow chart illustrating an example flow according to various embodiments; and

FIG. 10 is a flow chart illustrating an example flow according to various embodiments.

### DETAILED DESCRIPTION

### Introduction

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications Systems

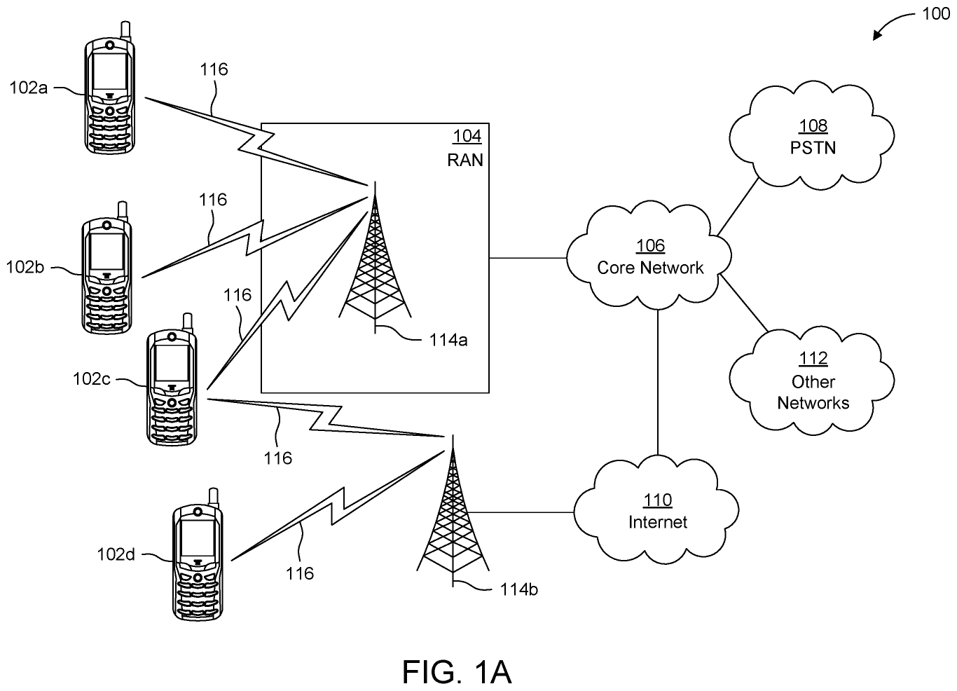

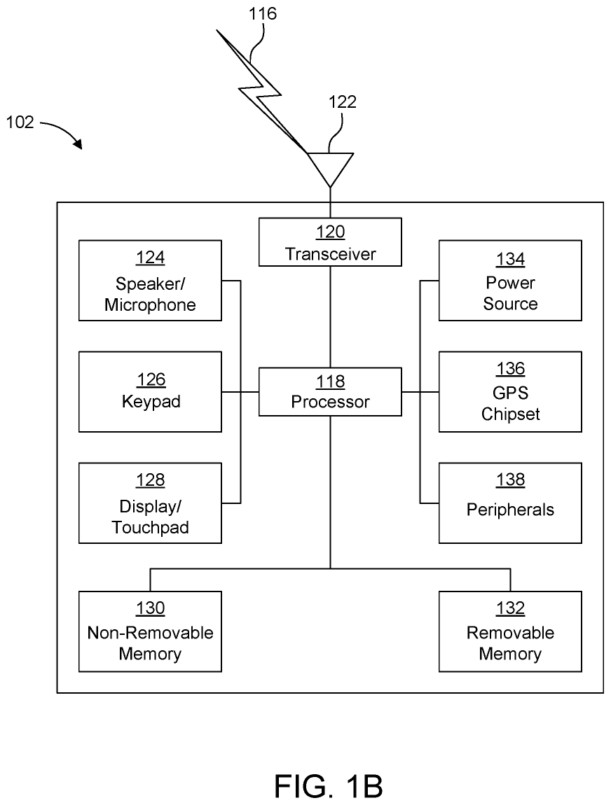

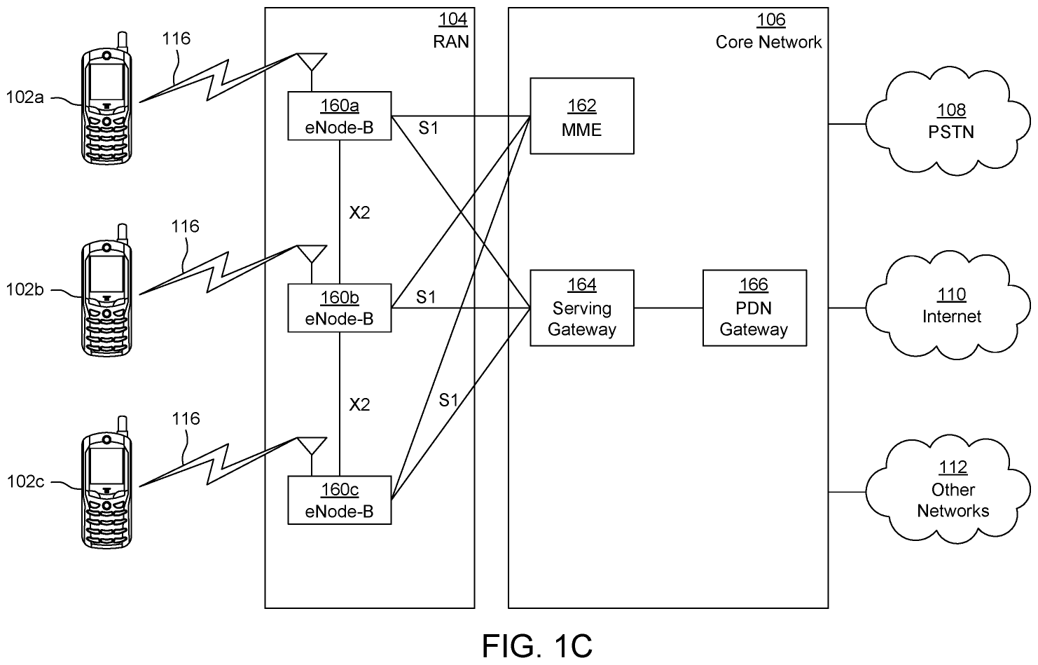

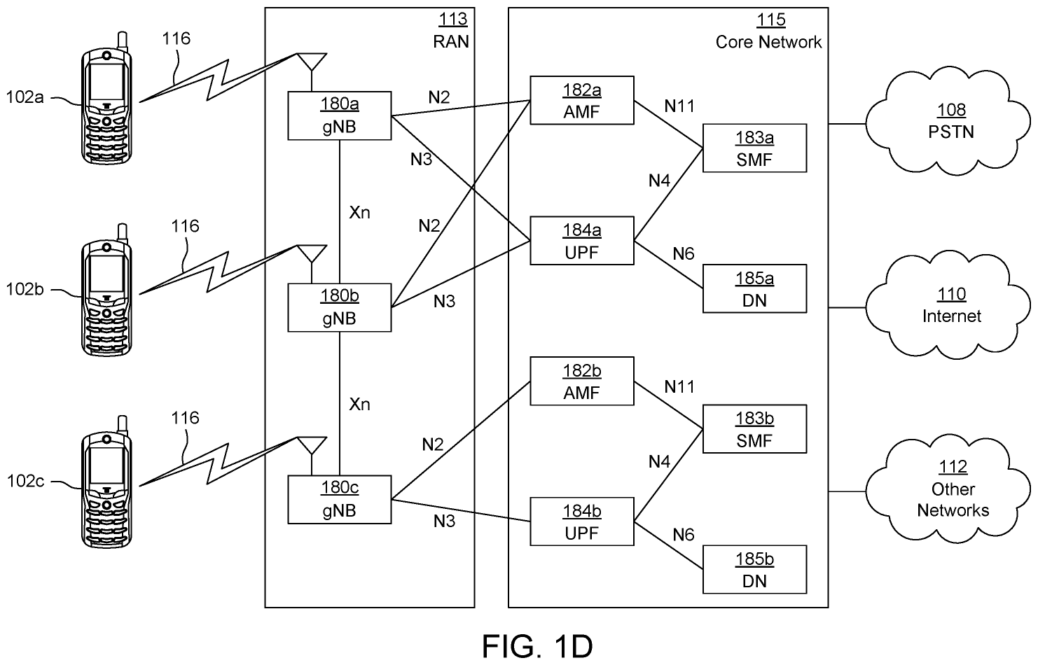

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

Methods, apparatuses, systems, etc. directed to access traffic steering, switching, and splitting (ATSSS) redundant traffic steering mode are disclosed herein.

In various embodiments, a method for, and/or for use in connection with, an ATSSS redundant traffic steering mode may be implemented in a WTRU and may include any of transmitting, to a first network element, first information indicating one of a request to establish a multi-access protocol data unit (PDU) session or a request to modify a multi-access PDU session; receiving, via a second network element, second information indicating a response to the one of the request to establish a multi-access PDU session or a request to modify a multi-access PDU session; determining first values of a plurality of metrics for a first access network; determining second values of the plurality of metrics for a second access network; determining to transmit a PDU associated with the multi-access PDU session via a on of (i) the first access network, (ii) the second access network or (iii) the first and second access networks based on a rule for redundant steering mode and on the first and second values of the plurality of metrics satisfying respective conditions of the rule; and transmitting the PDU via the on of the first access network, the second access network or the first and second access networks.

In various embodiments, a method for, and/or for use in connection with, an ATSSS redundant traffic steering mode may be implemented in a WTRU and may include any of transmitting, to a first network element, first information indicating one of a request to establish a multi-access PDU session or a request to modify a multi-access PDU session; receiving, via a second network element, second information indicating a response to the one of the request to establish a multi-access PDU session or a request to modify a multi-access PDU session; determining first values of a plurality of metrics for a first access network; determining second values of the plurality of metrics for a second access network; determining to receive a PDU associated with the multi-access PDU session via a on of (i) the first access network, (ii) the second access network or (iii) the first and second access networks based on a rule for redundant steering mode and on the first and second values of the plurality of metrics satisfying respective conditions of the rule; and receiving the PDU via the on of the first access network, the second access network or the first and second access networks.

In various embodiments, a method for, and/or for use in connection with, an ATSSS redundant traffic steering mode may be implemented in a WTRU and may include any of transmitting, to a first network element, first information indicating one of a request to establish a multi-access protocol data unit (PDU) session or a request to modify a multi-access PDU session; receiving, via a second network element, second information indicating a response to the one of the request to establish a multi-access PDU session or a request to modify a multi-access PDU session; determining to transmit or to receive a PDU associated with the multi-access PDU session via a on of (i) the first access network, (ii) the second access network or (iii) the first and second access networks based on a rule for redundant steering mode, on first values of a plurality of metrics for a first access network and second values of the plurality of metrics for a second access network satisfying respective conditions of the rule; and performing one of transmitting and receiving the PDU via the on of the first access network, the second access network or the first and second access networks.

In various embodiments, a method for, and/or for use in connection with, an ATSSS redundant traffic steering mode may be implemented in a WTRU and may include any of transmitting, to a first network element, first information indicating one of a request to establish a multi-access PDU session or a request to modify a multi-access PDU session and one or more redundant steering mode capabilities of the WTRU; receiving, via a second network element, second information indicating a response to the one of the request to establish a multi-access PDU session or a request to modify a multi-access PDU session and one or more rules for redundant steering mode, including the rule; determining to transmit or to receive a PDU associated with the multi-access PDU session via a on of (i) the first access network, (ii) the second access network or (iii) the first and second access networks based on one of the rules, on first values of a plurality of metrics for a first access network and second values of the plurality of metrics for a second access network satisfying respective conditions of the rule; and performing one of transmitting and receiving the PDU via the on of the first access network, the second access network or the first and second access networks.

In various embodiments, an apparatus for, and/or for use in connection with, an ATSSS redundant traffic steering mode may be configured to receive, via the second network element during a registration procedure, third information indicating that traffic steering is supported; transmit, to a first network element, first information indicating one of a request to establish a multi-access PDU session or a request to modify a multi-access PDU session; receive, via a second network element, second information indicating a response to the one of the request to establish a multi-access PDU session or a request to modify a multi-access PDU session; determine first values of a plurality of metrics for a first access network; determine second values of the plurality of metrics for a second access network; determine to transmit a PDU associated with the multi-access PDU session via a on of (i) the first access network, (ii) the second access network or (iii) the first and second access networks based on a rule for redundant steering mode and on the first and second values of the plurality of metrics satisfying respective conditions of the rule; and/or transmit the PDU via the on of the first access network, the second access network or the first and second access networks.

In various embodiments, an apparatus for, and/or for use in connection with, an ATSSS redundant traffic steering mode may be configured to transmit, to a first network element, first information indicating one of a request to establish a multi-access protocol data unit (PDU) session or a request to modify a multi-access PDU session; receive, via a second network element, second information indicating a response to the one of the request to establish a multi-access PDU session or a request to modify a multi-access PDU session; determine first values of a plurality of metrics for a first access network; determine second values of the plurality of metrics for a second access network; determine to receive a PDU associated with the multi-access PDU session via a on of (i) the first access network, (ii) the second access network or (iii) the first and second access networks based on a rule for redundant steering mode and on the first and second values of the plurality of metrics satisfying respective conditions of the rule; and receive the PDU via the on of the first access network, the second access network or the first and second access networks.

In various embodiments of the methods and apparatus, the PDU is a PDU of an SDF associated with the multi-access PDU session. In various embodiments of the methods and apparatus, based on the rule. a state transition of the redundant steering mode from inactive to active is carried out on condition that only a single one of the first and second access networks cannot satisfy requirements of the SDF. In various embodiments of the methods and apparatus, based on the rule. a state transition of the redundant steering mode from active to inactive is carried out on condition that only a single one of the first and second access networks can satisfy requirements of the SDF.

In various embodiments of the methods and apparatus, information indicating a duration for a state of the redundant steering mode is received from the network. In various embodiments of the methods and apparatus, information indicating which of the first or second access network to use is received for the duration. In various embodiments of the methods and apparatus, measurements on any of the first and second access networks that are removed are paused for the duration. In various embodiments of the methods and apparatus, the WTRU transitions to IDLE mode on the accesses that are removed for the duration.

In various embodiments of the methods and apparatus, the first information indicates one or more redundant steering mode capabilities of the WTRU, and wherein the second information indicates one or more rules for redundant steering mode, including the rule.

In various embodiments of the methods and apparatus, the plurality of metrics network element is an access and mobility management function. In various embodiments of the methods and apparatus, the second network element is a base station. In various embodiments of the methods and apparatus, the second network element is a base station associated with a second, different than the first, one of the first access network, the second access network or the first and second access networks.

In various embodiments of the methods and apparatus, the plurality of metrics comprises any two of a packet loss rate, a delay, a variability of delay and load.

In various embodiments of the methods and apparatus, the one or more rules for redundant steering mode include information indicating that an initial state of the redundant steering mode is one of active and inactive. In various embodiments of the methods and apparatus, initial PDU transmissions of the SDF are transmitted over the one of the first access network, the second access network or the first and second access networks based on the initial state of the redundant steering mode being one of active and inactive.

In various embodiments of the methods and apparatus, the one or more rules comprises information indicating a measurement configuration for the plurality of metrics. In various embodiments of the apparatus, wherein circuitry is configured to expect to receive information indicating at least one rule for redundant steering mode based on transmitting the first information indicating the one or more redundant steering mode capabilities of the WTRU. In various embodiments of the methods, the method may include expecting to receive information indicating at least one rule for redundant steering mode based on transmitting the first information indicating the one or more redundant steering mode capabilities of the WTRU.

In various embodiments of the methods, the method may receive, via the second network element during a registration procedure, third information indicating that traffic steering is supported. In various embodiments of the methods, determining to transmit a PDU may include determining to transmit a PDU via the first and second access networks based on the rule, on the first and second values of the plurality of metrics satisfying respective conditions of the rule, and on the rule indicating PDU duplication for the redundant steering mode is inactive, and transmitting the PDU may include transmitting the PDU based on the indicated PDU duplication.

In various embodiments of the apparatus, the circuitry being configured to determine to transmit or receive a PDU comprises the circuitry being configured to: determine to transmit a PDU via the first and second access networks based on the rule, on the first and second values of the plurality of metrics satisfying respective conditions of the rule, and on the rule indicating PDU duplication for the redundant steering mode is inactive, and the circuitry being configured to transmit the PDU comprises the circuitry being configured to: transmit the PDU based on the indicated PDU duplication.

In various embodiments, among the methods is a method that may be implemented in a WTRU and may include any of receiving, from a network element during a registration procedure, first information indicating that traffic steering is supported; transmitting, to a first network element, second information that may indicate one or more redundant steering mode capabilities of the WTRU; [0083] receiving, e.g., via a second network element, third information, wherein the third information may indicate one or more rules for redundant steering mode; and transmitting a PDU associated with the multi-access PDU session via at least one of first and second access networks, wherein: (i) the PDU is transmitted via the first and second access networks based on a first of the rules and first values of two or more metrics associated with each of the first and second access networks, and (ii) the PDU is transmitted via one of the first and second access networks based on a second of the rules and second values of two or more metrics associated with each of the first and second access networks.

In various embodiments, the first network element may be, for example, an AMF. In various embodiments, the first information may be or include a multi-access PDU session support indicator.

In various embodiments, the redundant steering mode capabilities of the WTRU may be or include ATSSS capabilities. In various embodiments, the ATSSS capabilities (the redundant steering mode capabilities) may include any of support for redundant traffic steering mode, support for duplicated detection, support for a specific steering functionality. In various embodiments, the second information may indicate one of a request to establish a multi-access protocol PDU session or a request to modify a multi-access PDU session. By way of example, the second information may be a PDU session establishment request, or a PDU session modification request, having information regarding redundant steering mode capabilities of the WTRU.

In various embodiments, the third information may indicate a response to the one of the request to establish a multi-access PDU session or a request to modify a multi-access PDU. By way of an example, the third information may be a PDU session establishment request acceptance message having information regarding (e.g., indicating) at least one of ATSSS rules for redundant steering mode and other rules for redundant steering mode. In various embodiments, the WTRU may expect to receive information indicating at least one rule for redundant steering mode based on transmitting the first information indicating the one or more redundant steering mode capabilities of the WTRU.

In various embodiments, at least one of the one or more rules indicates PDU duplication for the redundant steering mode is inactive (or active), and the WTRU may be configured to transmit the PDU based on the indicated PDU duplication based on lacking any value for one or more of the metrics associated with each of the first and second access networks. In various embodiments, the first rule nay indicate to use the first and second access networks on condition that neither (i) the first values of the two or more metrics associated with the first access network nor (ii) the first values of the two or more metrics associated with the second access network satisfy respective thresholds.

In various embodiments, among the methods is a method that may be implemented in a WTRU and may include any of transmitting, by the WTRU, a packet data unit (PDU) session establishment request having information regarding redundant steering mode capabilities of the WTRU; receiving, by the WTRU, a PDU session establishment request acceptance message having information regarding (e.g., indicating) at least one of ATSSS rules for redundant steering mode and other rules for redundant steering mode; transmitting one or more PDUs in a redundant steering mode according to at least one of the ATSSS rules or the other rules.

In various embodiments, transmitting the one or more PDUs may include toggling between active and inactive states of the redundant steering mode based on one or more trigger conditions. Alternatively, the method may include any of toggling between active and inactive states of the redundant steering mode based on one or more trigger conditions; and transmitting the one or more PDUs based on the active or inactive state resulting from the toggling (e.g., each of one or more instances of the toggling).

In various embodiments, transmitting the one or more PDUs may include monitoring the one or more trigger conditions for a transition from an active redundant steering mode to an inactive redundant steering mode based on one or more performance metrics. Alternatively, the method may include any of monitoring the one or more trigger conditions for a transition from an active redundant steering mode to an inactive redundant steering mode based on one or more performance metrics; and transmitting the one or more PDUs based on the inactive state, responsive to detecting (determining) the transition and the active state prior to transition or detecting (determining) the transition.

In various embodiments, the method may include receiving, by the WTRU, an indication from a user plane function (UPF) to trigger a state transition of redundant steering mode; and toggling between active and inactive states of redundant steering mode in response to the received indication.

In various embodiments, the method may include determining, by the WTRU, a trigger condition for state transition of redundant steering mode based on mobility events.

In various embodiments, the method may include any of receiving, by the WTRU from a performance management function (PMF), a signal for the WTRU to inform a UPF about a change in state of redundant steering mode; and informing the UPF, by the WTRU in response to the signal, about the change in state of redundant steering mode.

In various embodiments, among the apparatuses is a WTRU, including a transmitter, a receiver, a processor and memory, configured to perform a method in accordance with at least one of the various embodiments disclosed supra (and infra).

### Representative Methods and Apparatus for Access Traffic Steering, Switching, and Splitting (ATSSS) Redundant Traffic Steering Mode

### Representative ATSSS in 3GPP

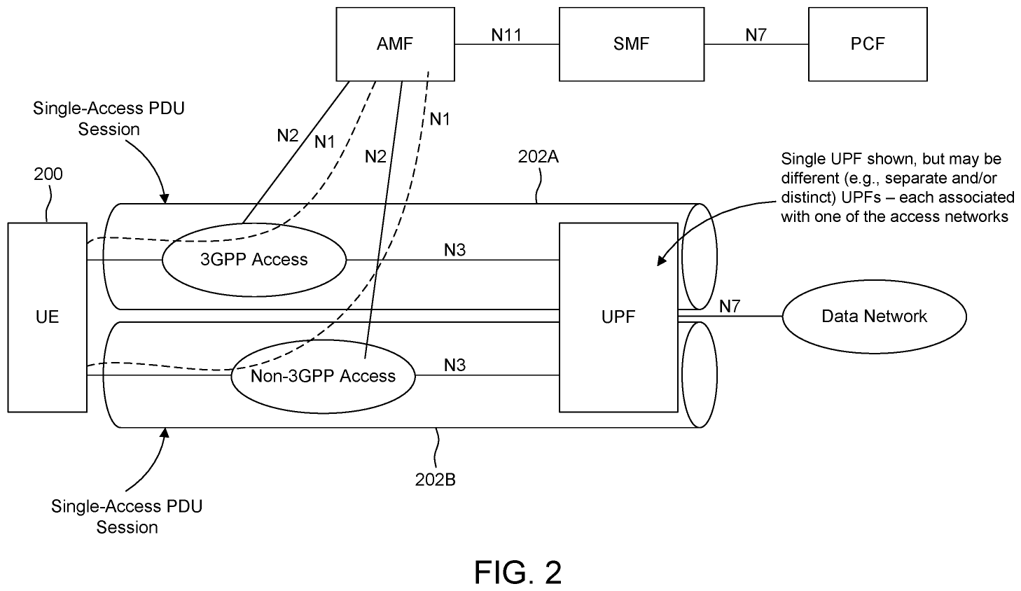

Most WTRUs are capable of both 3GPP access and non-3GPP access. This capability provides flexibility to the network operators in determining which access networks to use for a service data flow (SDF). Per 3GPP Release 15, and as shown in FIG. 2, a UE 200 using both 3GPP and non-3GPP access networks is required to establish independent single-access PDU sessions 202A and 202B over the 3GPP and non-3GPP access networks, respectively. The terms “packet data unit” and its abbreviation “PDU” may be referred to interchangeably with the terms “protocol data unit” (e.g., in accordance with 3^{rd} Generation Partnership Project (“3GPP”); Technical Specification Group Services and System Aspects; System architecture for the 5G System (5GS); Stage 2, (Release 17), 3GPP TS 23.501 v17.3.0.).

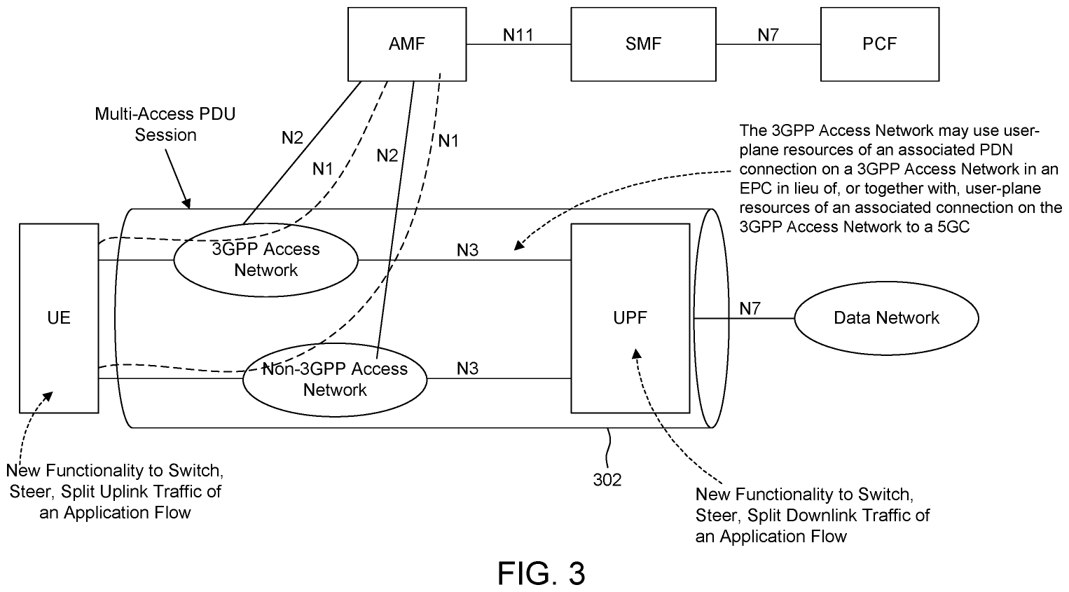

However, it was clear that such an architecture could not take full advantage of the flexibility. In Release 16, and as shown in FIG. 3, the notion of a multi-access PDU session 302 was introduced, allowing uplink and downlink traffic of a SDF to be more easily steered, switched, or split between the 3GPP and non-3GPP access networks. As used herein, a multi-access PDU session is a PDU session whose traffic can be sent over one, some or all of a plurality of access networks. For example, traffic of the multi-access PDU session 302 may be transmitted over a first of two access networks (e.g., a 3GPP access network), over a second of the two access networks (e.g., a non-3GPP access network), or over both of the two access networks (e.g., a 3GPP access network and a non-3GPP access network).

The new architecture introduced in Release 16 was further enhanced in Release 17 and allowed the following “steering functionalities”: (i) access traffic steering, (ii) access traffic switching, and (iii) access traffic splitting.

The access traffic steering functionality is a procedure by which (i) an access network for a new data flow is selected and (ii) traffic of that data flow transfers over the selected access network. Access traffic steering is applicable between 3GPP and non-3GPP accesses.

The access traffic switching functionality is a procedure by which all traffic of an ongoing data flow is moved from one access network to another access network in a way that maintains the continuity of the data flow. Access traffic splitting is applicable between 3GPP and non-3GPP accesses.

The access traffic splitting functionality is a procedure by which traffic of a data flow is split across multiple access networks. Access traffic splitting is applicable between 3GPP and non-3GPP accesses. When traffic splitting is applied to a data flow, some traffic of the data flow is transferred via one access and some other traffic of the same data flow is transferred via another access. Access traffic splitting is applicable between 3GPP and non-3GPP accesses.

The steering functionality in an ATSSS-capable WTRU can steer, switch, and/or split traffic of a multi-access PDU session across 3GPP access and non-3GPP access. Two steering functionalities have been standardized. The first is a high-layer steering functionality, which operates above the IP layer. In Release 17, only one high-layer steering functionality was specified, which applies the multipath TCP (MPTCP) protocol (IETF RFC 8684) and is called “MPTCP functionality”. This functionality is only applicable to TCP traffic. The second is a low-layer steering functionality, which operates below the IP layer. In Release 17, only one type of low-layer steering functionality was defined and is referred to as “ATSSS Low-Layer functionality” or “ATSSS-LL functionality.” The ATSSS-LL functionality is applicable to Ethernet and IP (i.e., TCP and UDP). The steering functionality (e.g., any of the MPTCP functionality and ATSSS-LL functionality) is new functionality that exists in both the WTRU and a UPF (i.e., in the endpoints of a PDU session).

For each steering functionality one or more steering modes are supported. A steering mode determines how traffic of a matching SDF should be distributed across 3GPP and non-3GPP access networks. The steering modes supported as of Release 16 include: (i) an active standby steering mode, (ii) a smallest delay steering mode, (iii) a load balancing steering mode, and (iv) a priority based steering mode.

The active standby steering mode is used to steer traffic to one access network (an active access network) when such access network is available, and switch to steering the traffic to another access network (a standby access network) when the one (active) access network becomes unavailable.

The smallest delay steering mode is used to steer traffic to an access network that is determined to have a smallest round-trip time (RTT). A WTRU and a UPF measure respective RTTs to determine which access network has the lowest RTT. Per 3GPP specifications as of Release 16, the smallest delay steering mode can only be used for a non-guaranteed bit rate (non-GBR) SDF.

The load balancing steering mode is used to split traffic across both access networks according to a percentage for how much traffic that should be sent over 3GPP access and over non-3GPP access. Per 3GPP specifications as of Release 16, the load balancing steering mode is only applicable to a non-GBR SDF.

The priority based steering mode is used to steer all traffic matching a rule, promulgated by a policy charging control (PCC) network element, to a high priority access network, until such access network is determined to be congested. After the high priority access network is determined to be congested, some of the traffic is sent also to a low priority access, i.e., the traffic is split over the two access networks. Per 3GPP specifications as of Release 16, the priority based steering mode can only be used for a non-GBR SDF.

The active standby, smallest delay, load balancing and a priority based steering modes were enhanced in Release 17. For the load balancing steering mode, 3GPP added a steering mode indicator. The steering mode indicator indicates that a WTRU may change default steering parameters in steering mode percentages provided by the network and may adjust the traffic steering based on its own decisions. Only one of the following steering mode indicators may be provided: (i) an autonomous load-balance indicator and (ii) a UE-assistance indicator.

When the autonomous load-balance indicator is provided to a WTRU, the WTRU may ignore the percentages in the steering mode component (i.e., the default percentages provided by the network) and may autonomously determine its own percentages for traffic splitting, in a way that maximizes the aggregated bandwidth in the uplink direction. When the UE-assistance indicator is provided to the WTRU by the network, it indicates to the WTRU that (a) the WTRU may decide how to distribute the uplink traffic of a matching SDF based on an internal state of the WTRU (e.g., when the WTRU is in a special internal state, e.g., lower battery level), and that (b) the WTRU may inform a corresponding UPF how it decided to distribute the uplink traffic of the matching SDF. In the cases where the WTRU is not in the special internal state, the WTRU shall distribute the uplink traffic as indicated by the network, even if the UE-assistance indicator is provided by the network.

In addition, for the load balancing steering mode, 3GPP introduced threshold values for the WTRU and the UPF to apply to measurements made for (or in connection with) the load balancing steering mode. The threshold value per access network may be either a value for a RTT measurement or a value for a packet loss rate (PLR) measurement. When at least one measured parameter (i.e., RTT or PLR) on one access network exceeds the threshold value (provided to the WTRU and the UPF), the WTRU and the UPF may stop sending traffic on this access network or may continue sending traffic on this access network but should reduce the traffic on this access network by an implementation specific amount and shall send the amount of reduced traffic on the other access network. When all measured parameters (i.e., RTT and PLR) for both accesses do not exceed the provided threshold values, the WTRU and the UPF shall apply the fixed split percentages.

For the priority-based steering mode, 3GPP also introduced threshold values for the WTRU and the UPF to apply to measurements made for (or in connection with) the priority based steering mode. The threshold value per access network may be either a value for a RTT measurement or a value for a PLR measurement. These threshold values should be considered by the WTRU and the UPF to determine when an access network becomes congested. For example, when a measured parameter (i.e., RTT or PLR) on the high priority access network exceeds the threshold value (provided to the WTRU and the UPF), the WTRU and the UPF may consider the high priority access as congested and send the traffic also to the low priority access network.

To enable the steering modes for each of the steering functionalities, rules are necessary at both the WTRU and the UPF. These rules are generated by a SMF, based on information known to the policy control function (PCF), and sent to the WTRU (ATSSS rules) for determining switching functionality and switching mode to use for uplink traffic, and are sent to the UPF (N4 rules) for determining switching functionality and switching mode to use for downlink traffic.

In addition, to support some of the steering modes, a performance management function (PMF) protocol is necessary at the WTRU and the UPF to make measurements necessary for switching mode decisions (RTT measurements, an access availability/unavailability report, PLR measurements).

3GPP Technical Specification Group Service and System Aspects (TSG SA) workgroup1 (SA1), in 3GPP; Service requirements for the 5G system, 3GPP TS 22.261 V18.5.0, has described a number of vertical markets and applications where the 5G system is supposed to be able to provide data transfer capability with strict performance requirements in terms of very low latency and high reliability requirements. These use cases are often referred to as requiring URLLC. Solutions to URLLC use cases have been addressed both in the access network side (e.g., pre-emption) as well as the core network side (session and service continuity (SSC) modes, dual connectivity based end-to-end redundant user plane paths). However, these solutions fail to consider the potential redundancy with a multi-access PDU session.

Among the problems that are addressed by the various disclosed embodiments is how and when to use the redundant steering mode.

In both cases (i.e., static redundant steering mode and dynamic redundant steering mode), the legacy PDU session establishment procedure does not support the new steering mode.

Disclosed hereinbelow are new criteria and/or triggers for the dynamic steering mode, including new criteria and/or triggers for both the WTRU and the UPF for determining when to activate or deactivate the steering mode. The criteria and/or triggers may be based on existing measurements as well as new measurements tailored to the URLLC use cases.

The features, methodologies and technologies disclosed herein include: (1) an enhanced PDU session establishment procedure including ATSSS capability for redundant steering mode and/or ATSSS rules and WTRU rules for redundant steering mode; (2) a redundant steering mode that may toggle/switch between active and inactive states based on trigger conditions; (3) monitoring trigger conditions for active to inactive transition of the redundant steering mode based on performance metrics; (4) monitoring trigger conditions for inactive to active transition of redundant steering mode based on performance metrics; (5) receiving, at a WTRU, an indication from a UPF to trigger a state transition of the redundant steering mode; (6) determining, at a WTRU, a trigger condition for state transition of redundant steering mode based on mobility events; and (7) a PMF signaling exchange for WTRU to inform the UPF about a change in state of redundant steering mode.

### Representative Overall Operation

In the following, the terms “service data flow” or its abbreviation “SDF” is used to describe traffic from an application that may or might be impacted by a steering mode. It may be identified by an IP 5-tuple, by a specific application ID, or any identifier that may identify the flow of an application. The terms “access” and “accesses” may be referred to interchangeably with the terms “access network” and “access networks” (e.g., respectively), and use of the term “network” in the terms “access network” and “access networks” does not imply that an “access network” and/or any one of the “access networks” necessarily includes more than one network element.

A WTRU and a UPF may be configured with a multi-access PDU session and the WTRU and the UPF may transmit PDUs over a 3GPP path and/or a non-3GPP path. In the following, the terms “access path” may be used interchangeably with “access leg”.

Redundant steering mode allows PDUs to be duplicated and transmitted over two (or more) access networks (e.g., a 3GPP access network and a non-3GPP access network). In the following, the terms “static redundant steering mode” and the terms “static duplication” are used interchangeably and should be understood as a steering mode which does not change very dynamically. It is typically expected to be fixed for a duration of an SDF. All PDUs of this SDF may be subject to the steering mode and be transmitted over two (or more) access networks (e.g., a 3GPP access network and a non-3GPP access network). Static duplication implies that all of the PDUs of an SDF will be duplicated over the two (or more) access networks.

In the following, the terms “latency requirement” and the terms “delay requirement” are used interchangeably.

In the following, the terms “dynamic redundant steering mode” and the terms “dynamic duplication” are used interchangeably and should be understood as a steering mode which is not static. The dynamic redundant steering mode may have two (or more) states and may be in only one of the two (or more) states at any time. The first state may be an active state (where duplication occurs) and the second state may be an inactive state (where there is no duplication). The dynamic redundant steering mode may undergo a change in state from the active state to the inactive state, and/or a change from the inactive state to the active state. Although being triggered to be in, or transition to, a new state (e.g., one of the active state or the inactive state) or transitioning to the new state may be considered as other states of the dynamic redundant steering mode. However, for simplicity of exposition herein, the dynamic redundant steering mode is considered to remain in the current state (e.g., active or inactive) until the transition to the new state (e.g., the converse of the current state) has been completed.

In the active state, PDUs of an SDF may be transmitted over two (or more) access networks (e.g., a 3GPP access network and a non-3GPP access network). In the inactive state, PDUs of an SDF may be transmitted only over a single access network (e.g., one of a 3GPP access network or a non-3GPP access network) using another steering mode, such as the active standby mode. During the active state, a WTRU and a UPF may monitor a trigger set (e.g., a first trigger set (“trigger set 1”)) to determine whether to continue transmission over two (or more) access networks (i.e., stay in active state) or to only transmit PDUs over a single access network (i.e., transition to inactive state). During the inactive state, the WTRU and the UPF may monitor a trigger set (e.g., a second trigger set (“trigger set 2”)) to determine whether to continue transmission over a single access network (i.e., stay in inactive state) or transmit PDUs over two (or more) access network (i.e., transition to active state). Each of the trigger sets denotes a group or set of trigger conditions that a WTRU and a UPF may monitor to make change in state (e.g., whether to transition) decisions. Dynamic duplication implies that only select PDUs of an SDF will be duplicated over both accesses. The selection of these PDUs is based on the trigger conditions, which are also referred to as the duplication criteria. In the active state, the WTRU and the UPF have used the duplication criteria to determine that the PDUs should be duplicated over two (or more) access networks. In the inactive state, the WTRU and the UPF have used the duplication criteria to determine that the PDUs should not be duplicated over two (or more) access networks. In the inactive state, the duplication criteria may also determine which single access to use (3GPP or non 3GPP).

The following procedures can be applied by ATSSS-capable WTRUs and 5GC networks. A WTRU may determine whether ATSSS is supported by the network based on a multi-access PDU session support indicator that may be provided by an AMF during registration procedures, e.g., as specified in clause 4.22.9.1 of 3GPP; Technical Specification Group Services and System Aspects; Procedures for the 5G System (5GS); Stage 2, (Release 17), 3GPP 23.502 v17.3.0. If both the WTRU and 5GC are ATSSS capable, the network may decide to enable or disable redundant steering mode. If enabled, the network may further decide whether to employ static duplication or dynamic duplication.

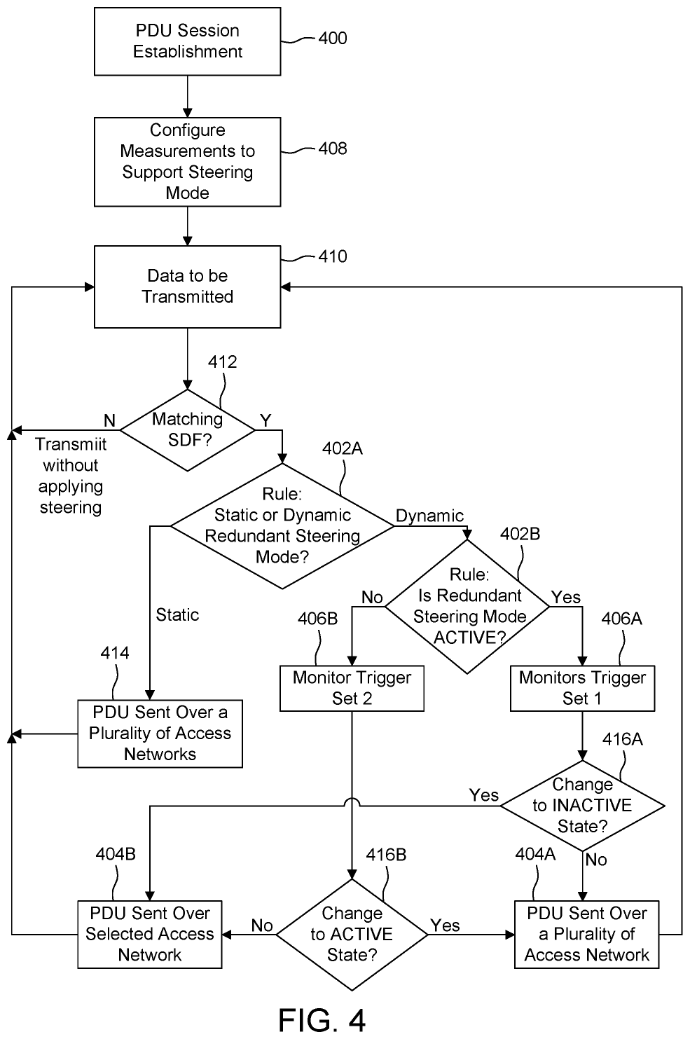

FIG. 4 is a flow diagram illustrating redundant steering mode operation according to various embodiments. The redundant steering mode operation shown in FIG. 4 may be suitable as a procedure at a WTRU and a UPF for the redundant steering mode. Of note in this procedure are: 1) a referral to an enhanced PDU session establishment procedure, 2) rules configuring various options for the redundant steering mode (e.g., static vs dynamic), 3) different states of the dynamic redundant steering mode (e.g., active and inactive), and 4) new monitoring and triggering events to move from the different states of the dynamic redundant steering mode.

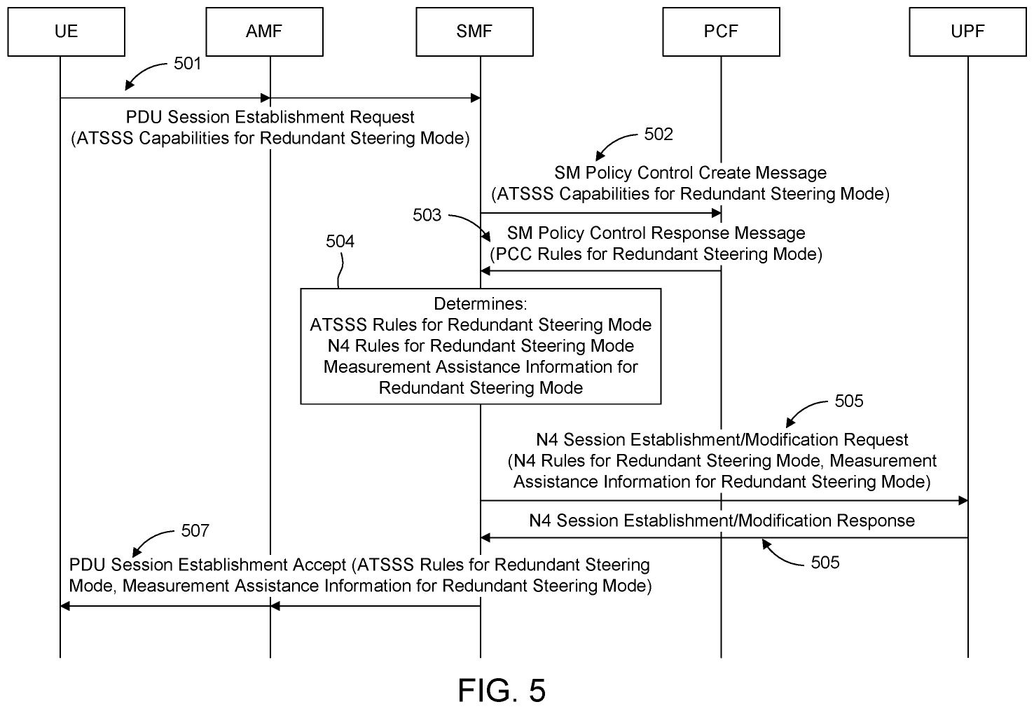

Referring to FIG. 4, the WTRU may perform an enhanced PDU session establishment procedure (400) as further detailed below with reference to FIG. 5. The WTRU may configure measurements to support the redundant steering mode (408) and may generate, receive, and/or determine uplink data to be transmitted at the WTRU (410). The WTRU may determine whether the uplink data matches an SDF subjected to the redundant steering mode (412) and, if not, may forego traffic steering and may transmit the uplink data (without applying steering). If the WTRU determines that the uplink data matches an SDF subjected to the redundant steering mode (412), then the WTRU may determine whether to perform static or dynamic redundant steering according to a rule (402A). If the WTRU determines to perform static redundant steering according to (e.g., is required by) the rule (402A), then the WTRU may send one or more PDUs of the uplink data over two (or more access networks, Alternatively, if the WTRU determines to perform dynamic redundant steering according to (e.g., is required by) the rule (402A), then the WTRU may determine whether the dynamic redundant steering mode is in active state according to a rule (402B).

If the WTRU determines that the dynamic redundant steering is in the active state (402B), then the WTRU may monitor a first trigger set (406A) and may determine whether to change to inactive state (416A). If the WTRU determines not to change state (416A), then the WTRU may transmit one or more PDUs of the uplink data over two (or more) access networks (404A) and processing may return to (410). If the WTRU determines to change state (416A), then the WTRU may transmit one or more PDUs of the uplink data over a selected access (404B) and processing may return to (410).

If the WTRU determines that redundant steering is not in the active state (402B), then the WTRU may monitor a second trigger set (406B) and may determine whether to change to the active state (416B). If the WTRU determines not to change state (416B), then the WTRU may send one or more PDUs of the uplink data over a selected access network (404B) and processing may return to (410). If the WTRU determines to change state (416B), then the WTRU may transmit one or more PDUs of the uplink data over two (or more) access networks (404B) and processing may return to (410).

FIG. 4 and accompanying description supra apply to a case in which changes to the state of the redundant steering mode (e.g., made by the WTRU) occur at PDU transmission occasions. Alternatively, state transitions may also occur at non PDU transmission occasions. For example, the WTRU may continuously, continually or repeatedly monitor a triggering set (or duplication criteria) and may change the state of the dynamic redundant steering mode from duplication to no duplication and vice versa when one or more trigger condition are satisfied.

### Representative PDU Session Establishment Enhanced for Redundant Steering Mode

During establishment of a multi-access PDU session ((see FIG. 4, at (400)), a WTRU may transmit a PDU session establishment request to the AMF, over an access network (e.g., a 3GPP access network or a non 3GPP access network). In a network that does not support ATSSS, the WTRU may not be permitted to initiate: (i) a procedure to establish a multi-access PDU session, (ii) a procedure to establish a PDU Session with “multi-access PDU Network-Upgrade Allowed” indication, (iii) a procedure for adding user-plane resources over one access network for an existing multi-access PDU session established over another access network in a different mobile network, or (iv) a procedure to perform PDU session modification with a request type of “multi-access PDU request” or with “multi-access PDU Network-Upgrade Allowed” indication after moving from evolved packet core (EPC) to 5GC.

FIG. 5 is a signaling diagram illustrating an example enhanced PDU session establishment to support redundant steering mode according to one or more embodiments. At least some of the enhanced PDU session establishment shown in FIG. 5 may be suitable for performing the enhanced PDU session establishment procedure (400) of FIG. 4. An exchange of ATSSS capability for the redundant traffic steering mode and the ATSSS rules for the redundant traffic steering mode may apply to the PDU session modification procedure.

Referring to FIG. 5, a WTRU may transmit to a network (an AMF and an SMF) information in connection with establishing a PDU session (“PDU session establishment information”) (501). The PDU session establishment information may include information indicating a request for establishing a PDU session (“PDU session establishment request information”) and information indicating ATSSS capabilities of the WTRU for redundant traffic steering. In various embodiments, the PDU session establishment information may be, for example, a PDU session establishment request message that includes the information indicating ATSSS capabilities of the WTRU for redundant traffic steering. The WTRU may generate the PDU session establishment request message (e.g., according to a particular protocol) and may include the ATSSS capabilities of the WTRU for redundant traffic steering in such message. As part of the PDU session establishment, the WTRU provides the ATSSS capabilities to the AMF. To enable the redundant steering mode, the WTRU may include as part of the capability one or more of the following: (i) information indicating support for one or more redundant traffic steering modes, (ii) information indicating support for a static redundant traffic steering mode, (iii) information indicating support for a dynamic redundant traffic steering mode, (iv) information indicating support for redundant traffic steering mode over MPTCP, (v) information indicating support for redundant traffic steering mode over ATSSS-LL, and (vi) information indicating support for duplicated detection.

The information indicating support for redundant traffic steering mode may be an indication of whether redundant traffic steering mode is supported by the WTRU.

The information indicating support for a static redundant traffic steering mode may be an indication of whether a static redundant traffic steering mode is supported by the WTRU (e.g., the indication provided is one of a first indication that the static redundant traffic steering mode is supported by the WTRU and a second indication that the static redundant traffic steering mode is not supported by the WTRU). Alternatively, the information indicating support for a static redundant traffic steering mode may be an indication that the static redundant traffic steering mode is supported by the WTRU (e.g., the indication is provided if a static redundant traffic steering mode is supported by the WTRU, and no indication is provided if the WTRU does not support a static redundant traffic steering mode). Implicit in a static redundant traffic steering mode being supported by the WTRU is that the WTRU supports a redundant traffic steering mode. The information indicating support for a static redundant traffic steering mode may be provided in addition to, in lieu of, only if, and/or independent from the information indicating support for redundant traffic steering mode being provided.

The information indicating support for a dynamic redundant traffic steering mode may be an indication of whether a dynamic redundant traffic steering mode is supported by the WTRU (e.g., the indication provided is one of a first indication that the dynamic redundant traffic steering mode is supported by the WTRU and a second indication that the dynamic redundant traffic steering mode is not supported by the WTRU). Alternatively, the information indicating support for a dynamic redundant traffic steering mode may be an indication that the dynamic redundant traffic steering mode is supported by the WTRU (e.g., the indication is provided if the WTRU supports dynamic redundant traffic steering mode and no indication is provided if the WTRU does not support a dynamic redundant traffic steering mode). Implicit in a dynamic redundant traffic steering mode being supported by the WTRU is that the WTRU supports a redundant traffic steering mode. The information indicating support for a dynamic redundant traffic steering mode may be provided in addition to, in lieu of, only if, and/or independent from the information indicating support for redundant traffic steering mode being provided).

The information indicating support for redundant traffic steering mode over MPTCP may be an indication of whether redundant traffic steering mode over MPTCP is supported by the WTRU (e.g., the indication provided is one of a first indication that the redundant traffic steering mode over MPTCP is supported by the WTRU and a second indication that the redundant traffic steering mode over MPTCP is not supported by the WTRU). Alternatively, the information indicating support for redundant traffic steering mode over MPTCP may be an indication that the redundant traffic steering mode over MPTCP is supported by the WTRU (e.g., the indication is provided if the WTRU supports steering functionality at the MPTCP and no indication is provided if the WTRU does not support redundant traffic steering mode over MPTCP). Implicit in the redundant traffic steering mode over MPTCP being supported by the WTRU is that the WTRU supports a redundant traffic steering mode. The information indicating support for redundant traffic steering mode over MPTCP may be provided in addition to, in lieu of, only if, and/or independent from the information indicating support for redundant traffic steering mode being provided.

The information indicating support for redundant traffic steering mode over ATSSS-LL may be an indication of whether redundant traffic steering mode over ATSSS-LL is supported by the WTRU (e.g., the indication provided is one of a first indication that the redundant traffic steering mode over ATSSS-LL is supported by the WTRU and a second indication that the redundant traffic steering mode over ATSSS-LL is not supported by the WTRU). Alternatively, the information indicating support for redundant traffic steering mode over ATSSS-LL may be an indication that the redundant traffic steering mode over ATSSS-LL is supported by the WTRU (e.g., the indication is provided if the WTRU supports the steering functionality at the ATSSS-LL and no indication is provided if the WTRU does not support redundant traffic steering mode over ATSSS-LL). Implicit in the redundant traffic steering mode over ATSSS-LL being supported by the WTRU is that the WTRU supports a redundant traffic steering mode. The information indicating support for redundant traffic steering mode over ATSSS-LL may be provided in addition to, in lieu of, only if, and/or independent from the information indicating support for redundant traffic steering mode being provided.

The information indicating support for duplicated detection may be an indication of whether duplicate detection and discard functionality is supported by the WTRU (e.g., the indication provided is one of a first indication that duplicate detection and discard functionality is supported by the WTRU and a second indication that duplicate detection and discard functionality is not supported by the WTRU). Alternatively, the information indicating support for duplicate detection and discard functionality may be an indication that the duplicate detection and discard functionality is supported by the WTRU (e.g., the indication is provided if the WTRU supports duplicate detection and discard functionality and no indication is provided if the WTRU does not support duplicate detection and discard functionality). The information indicating support for duplicate detection and discard functionality may be provided in addition to, in lieu of, only if, and/or independent from the information indicating support for redundant traffic steering mode over ATSSS-LL. The information indicating support for duplicate detection and discard functionality may be provided in addition to, in lieu of, only if, and/or independent from the information indicating support for redundant traffic steering mode being provided.

Although not shown, the support of redundant traffic steering mode may be indicated over any number of steering functionalities.

The SMF may interact with a PCF to obtain PCC rules for the redundant steering mode (502-503), e.g., based on the ATSSS capabilities. The SMF may determine ATSSS rules for the redundant steering mode, N4 rules for the redundant steering mode, and any measurement assistance information for redundant steering (504), e.g., based on the PCC rules for the redundant steering mode. The ATSSS rules and the N4 rules may include and/or indicate information specific (pertaining) to the redundant steering mode. The information specific (pertaining) to the redundant steering mode may include, for example, and of: (i) an identifier of a SDF (“SDF identifier”), (ii) a priority of the redundant steering mode, (iii) information indicating whether the redundant steering mode applies to uplink or downlink or both uplink and downlink, (iv) information indicating whether the redundant steering mode is or should be a static redundant steering mode or a dynamic redundant steering mode, (v) information indicating that an initial or primary state of the dynamic steering mode is or should be active or inactive, (vi) information indicating that, if the dynamic steering mode is in an inactive state, an access network (e.g., a 3GPP access network or a non-3GPP access network) initial PDU transmissions of the SDF are or should be over, (vii) information indicating whether (or that) performing duplicate detection and discard is a requisite for the ATSSS-LL steering functionality, (viii) information indicating a default or fallback steering mode to use if traffic duplication is not needed (e.g., in a scenario in which requirements of the SDF can be satisfied using both a 3GPP leg and a non3GPP leg), and (ix) information indicating a measurement configuration to support the redundant steering mode.

In various embodiments, the information indicating a measurement configuration to support the redundant steering mode may include configuration details for a PMF, thresholds for triggering redundant steering mode state transitions, configuration details for new performance metrics, etc.

In some cases, the redundant steering mode for a WTRU-to-UPF portion of an uplink path (“WTRU-to-UPF path”) may be different from a UPF-to-WTRU portion of a downlink path (“UPF-to-WTRU path”). This may occur when the 3GPP leg uses Frequency Division Duplexing, and the uplink and downlink are on different spectrums. In such cases, performance metrics for the 3GPP leg may be different for the uplink and the downlink, and as a result duplication state may not necessarily be the same for uplink transmissions and downlink transmissions. To take this into account, the ATSSS rules and N4 rules may have separate information for uplink and downlink.

Although not shown, the SMF may check with a unified data manager (UDM) to determine if the redundant steering mode is allowed by subscription or, for example, if it is allowed in the home routed scenario. The SMF may assign a QoS profile to the access networks. In Release 17, for a GBR QoS flow, the SMF provides a QoS profile to a single access network. In case the PCC rule allows a GBR QOS flow in both access networks, the SMF decides which one of the access networks to provide the QoS profile for the GBR QoS flow based on its local policy. When the redundant steering mode is supported for a GBR QOS Flow, the SMF may provide a QoS profile to both access networks.

The SMF may transmit to the UPF information in connection with establishing and/or modifying an N4 session (“N4 session establishment/modification information”) (505). The N4 session establishment/modification information may include information indicating a request for establishing/modifying an N4 session (“N4 session establishment/modification request information”) and information indicating the N4 rules and the measurement assistance information. In various embodiments, the N4 session establishment modification information may be, for example, a N4 session establishment/modification request message that includes the information indicating the N4 rules and the measurement assistance information. The SMF may generate the N4 session establishment/modification request message (e.g., according to a particular protocol) and may include the information indicating the N4 rules and the measurement assistance information in such message.

The UPF may receive the N4 session establishment modification information (505) and may determine and/or configure N4 rules based on the information indicating the N4 rules. The UPF may enable or disable redundant steering mode based on the N4 session establishment modification information (e.g., the N4 rules determined from the N4 session establishment modification information). The UPF may apply one or more of the N4 rules, e.g., if the redundant steering mode is enabled. The UPF, for example, may apply one or more of the N4 rules to determine details of the redundant steering mode. By way of example, the UPF may determine that duplication may be one of static and dynamic based on a first of the N4 rules, e.g., specifying that duplication is either static or dynamic. If determined to be dynamic, the UPF may determine that an initial state of duplication may be one of active and inactive based on a second of the N4 rules, e.g., specifying that the duplication state is either initially active or initially inactive. If determined to be inactive, the UPF may determine that a primary and/or initial leg is one of a 3GPP leg and a non3GPP leg based on a third of the N4 rules, e.g., specifying that the primary and/or initial leg is either a 3GPP leg or a non3GPP leg.

The UPF may transmit N4 session establishment/modification information to the SMF (506). The N4 session establishment/modification information may include information indicating a response to N4 session establishment/modification request information (“N4 session establishment/modification response information”). In various embodiments, the N4 session establishment modification information may be, for example, a N4 session establishment/modification response message. The SMF may generate the N4 session establishment/modification response message (e.g., according to a particular protocol).

The SMF may receive the N4 session establishment/modification information from the UPF (506). The SMF may transmit PDU session establishment information to the WTRU (507). The PDU session establishment information may include information indicating acceptance of the PDU session establishment (“PDU session establishment accept information”) and information indicating the ATSSS rules and the measurement assistance information. In various embodiments, the PDU session establishment information may be, for example, a PDU session establishment accept message that includes the information indicating the ATSSS rules and the measurement assistance information. The SMF may generate the PDU session establishment accept message (e.g., according to a particular protocol) and may include the information indicating the ATSSS rules and the measurement assistance information in such message.

The WTRU may receive the PDU session establishment information from the SMF (507) and may determine and/or configure the ATSSS rules based on the information indicating the ATSSS rules. The WTRU may enable or disable the redundant steering mode based on the PDU session establishment information (e.g., the ATSSS rules determined from the PDU session establishment accept information). The WTRU may apply one or more of the ATSSS rules, e.g., if the redundant steering mode is enabled. The WTRU, for example, may apply one or more of the ATSSS rules to determine details of the redundant steering mode. By way of example, the WTRU may determine that duplication may be one of static and dynamic based on a first of the ATSSS rules, e.g., specifying that duplication is either static or dynamic. If determined to be dynamic, the WTRU may determine that an initial state of duplication may be one of active and inactive based on a second of the ATSSS rules, e.g., specifying that the duplication state is either initially active or initially inactive. If determined to be inactive, the WTRU may determine that a primary and/or initial leg is one of a 3GPP leg and a non3GPP leg based on a third of the ATSSS rules, e.g., specifying that the primary and/or initial leg is a 3GPP leg or a non3GPP leg.

During normal operation, the WTRU and the UPF may follow the configured ATSSS rules and N4 rules, respectively. If the redundant steering mode is enabled and dynamic, the WTRU and UPF may monitor triggers (based on measurements or events) to determine the duplication state. If the ATSSS rules (or the N4 rules) specify that a WTRU (or a UPF) need not perform duplicate detection and discard, the WTRU (or UPF) assumes that this functionality will be handled by higher layers (e.g., the application).

### Representative Dynamic Redundant Steering Mode

Dynamic redundant steering mode may occur when redundant steering mode is enabled. A WTRU and a UPF may use duplication criteria to determine whether duplication is active or inactive. To enable the dynamic switching between active and inactive, the WTRU and the UPF may require and/or use performance measurements for each access network. The measurements may be configured, e.g., such as, in accordance with FIG. 4, at (408) and accompanying disclosure. The WTRU and UPF may make one or more of the following measurements: (i) one or more PLR measurements, (ii) one or more delay measurements, (iii) one or more variability of delay measurements, and (iv) one or more load measurements.

The PLR measurements for each access network may be a rate of PDU packet loss for the corresponding access network. Separate measurements may be made for uplink transmissions and downlink transmissions.

The delay measurements for each access network may be some measure of delay for the corresponding access network, such as, e.g., a round-trip delay or a one way delay for the corresponding access network. The one way delay may be measured from a WTRU to a UPF or from the UPF to the WTRU. Separate measurements may be made for uplink transmissions and downlink transmissions. The delay measurements may be denoted herein as the term “D.” Alternatively, the delay measurements for each access network may be an average (mean) of a measured round-trip delay for the corresponding access network or the measured one-way delay for the corresponding access network.

The variability of delay measurements for each access network may be a measure of the variability of the packet transmissions on a corresponding access network, such as, e.g., a variability of the round-trip delay or a one way delay for the corresponding access network. The variability measurements may come from different over-the-air scheduling mechanisms used for 3GPP and non-3GPP access networks, and/or different transport paths in a core network that may be used by a 3GPP RAN node and a non-3GPP interworking node (Non-3GPP Interworking Function (N3IWF), Trusted Non-3GPP Gateway Function (TNGF), Trusted WLAN Interworking Function (TWIF), Wireline Access Gateway Function (W-AGF)). Separate measurements may be made for uplink transmissions and downlink transmissions. The variability measurements may be any of: a statistical variance of the delay, a statistical standard deviation of the delay, a median of the delay, a k-th percentile of the delay, a maximum delay observed, minimum delay observed, etc. The variability of delay measurements may be denoted herein as the term “VAR”.

The load measurements for each access network may be a measure of a load on the corresponding access network, such as, e.g., a measurement of an over-the-air load, a transport network load (load in core network on the RAN to UPF/UPF to UPF (N3/N9) interface to the UPF), and a combination of the over-the-air load and transport network load measurements. Separate measurements may be made for uplink and downlink. The load measurements may be denoted herein as the term “L”.

The PLR, delay, and variability of delay measurements may be direction specific. For a WTRU, the measurements may be based on the uplink path (from WTRU to UPF), and/or for the UPF, the measurements may be based on the downlink path (from UPF to WTRU). In the following, measurements for an access network may be distinguished by an underscore. For example, PLR measurements of a first access may be denoted a PLR_1, delay measurements of a second access may be denoted as D_2. Various thresholds for PLR measurements (e.g., PLR_thresholdA_1, PLR_thresholdA_2, PLR_thresholdB 1, PLR_thresholdB_2, PLR_thresholdC_1, PLR_thresholdC_2, etc.) are referred to in the disclosure that follows. These thresholds may be configured and/or set by the network and may be configured set to the same or different values. The same applies to various thresholds for delay measurements (D), for variability of delay measurements (VAR), and for load measurements (L) referred to in the disclosure that follows.

### Representative Active to Inactive Transitions

A state transition of a dynamic redundant steering mode from active state to inactive state may occur, be triggered and/or be carried out based on one or more of various measurements, such as any of the measurements disclosed supra. By way of example, a WTRU and/or a UPF may trigger and/or carry out a state transition of dynamic redundant steering mode from active state to inactive state based on one or more of various measurements, such as, in accordance with FIG. 4, at (416A) and/or (416B) and accompanying disclosure.

In various embodiments, the state transition of the dynamic redundant steering mode from active state to inactive state may occur, be triggered and/or be carried out responsive to, based on, and/or in connection with any one or combination of various conditions occurring. The various conditions may include for example, (i) a PLR measurement for a first access network satisfying (e.g., being less than or equal to) a corresponding first of one or more PLR_thresholds (denoted herein as “PLR_1<PLR_thresholdA_1”); (ii) a PLR measurement for a second access network satisfying (e.g., being less than or equal to) a corresponding second of one or more PLR_thresholds (denoted herein as “PLR_2<PLR_thresholdA_2”); (iii) a delay measurement for the first access network satisfying (e.g., being less than or equal to) a corresponding first of one or more delay thresholds (denoted herein as “D_1<D_thresholdA_1”); (iv) a delay measurement for the second access network satisfying (e.g., being less than or equal to) a corresponding second of one or more delay thresholds (denoted herein as “D_2<D_thresholdA_2”); (v) a variability of delay measurement for the first access network satisfying (e.g., being less than or equal to) a corresponding first of one or more variability of delay thresholds (denoted herein as “VAR_1<VAR_thresholdA_1”); (vi) a variability of delay measurement for the second access network satisfying (e.g., being less than or equal to) a corresponding second of one or more variability of delay thresholds (denoted herein as “VAR_2<VAR_thresholdA_2”); (vii) a load measurement for the first access network satisfying (e.g., being greater than or equal to) a corresponding first of one or more load thresholds (denoted herein as “L_1>L_thresholdA_1”); (viii) a load measurement for the second access network satisfying (e.g., being greater than or equal to) a corresponding second of one or more load thresholds (denoted herein as “L_2>L_thresholdA_2”); (ix) a PLR measurement for a first access network satisfying (e.g., being greater than or equal to) a corresponding third of one or more PLR_thresholds (denoted herein as “PLR_1>PLR_thresholdB_1”); (x) a PLR measurement for a second access network satisfying (e.g., being greater than or equal to) a corresponding fourth of one or more PLR_thresholds (denoted herein as “PLR_2>PLR_thresholdB_2”); (xi) a delay measurement for the first access network satisfying (e.g., being greater than or equal to) a corresponding third of one or more delay thresholds (denoted herein as “D_1>D_thresholdB_1”); (xii) a delay measurement for the second access network satisfying (e.g., being greater than or equal to) a corresponding fourth of one or more delay thresholds (denoted herein as “D_2>D_thresholdB_2”); (xiii) a variability of delay measurement for the first access network satisfying (e.g., being greater than or equal to) a corresponding third of one or more variability of delay thresholds (denoted herein as “VAR_1>VAR_thresholdB_1”); (xiv) a variability of delay measurement for the second access network satisfying (e.g., being greater than or equal to) a corresponding fourth of one or more variability of delay thresholds (denoted herein as “VAR_2>VAR_thresholdB_2”); (xv) a load measurement for the first access network satisfying (e.g., being less than or equal to) a corresponding third of one or more load thresholds (denoted herein as “L_1<L_thresholdB_1”); and (xvi) a load measurement for the second access network satisfying (e.g., being less than or equal to) a corresponding fourth of one or more load thresholds (denoted herein as “L 2<L_thresholdA_2”).

The condition PLR_1<PLR_thresholdA_1, when satisfied, may indicate (e.g., be an indication) that the first access network may be able to satisfy the requirements of an SDF (e.g., for a non-trivial amount of time) and that, alone or in combination with one or more other satisfied and/or unsatisfied conditions, may obviate a need for redundant transmission over the second access network. A WTRU and/or a UPF may trigger and/or carry out a state transition of the dynamic redundant steering mode from active state to inactive state based on the condition PLR_1<PLR_thresholdA 1 being satisfied (e.g., alone or in combination with one or more other conditions being satisfied and/or unsatisfied).

The condition PLR_2<PLR_thresholdA_2, when satisfied, may indicate (e.g., be an indication) that the second access network may be able to satisfy the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition PLR 2<PLR_thresholdA 2being satisfied (e.g., alone or in combination with one or more other conditions being satisfied and/or unsatisfied). The PLR_thresholdA_2 and PLR_thresholdA_1 may have values specific to the second access network and the first access network, respectively, and the values may be same or different.

The condition D_1<D_thresholdA_1, when satisfied, may indicate (e.g., be an indication) that the first access network may be able to satisfy the requirements of the SDF (e.g., for a non-trivial amount of time) and that, alone or in combination with one or more other satisfied and/or unsatisfied conditions, may obviate a need for redundant transmission over the second access. A WTRU and/or a UPF may trigger and/or carry out a state transition of the dynamic redundant steering mode from active state to inactive state based on the condition D_1<D_thresholdA_1 being satisfied (e.g., alone or in combination with one or more other conditions being satisfied and/or unsatisfied).

The condition D_2<D_thresholdA_2, when satisfied, may indicate (e.g., be an indication) that the second access network may be able to satisfy the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition D_2<D_thresholdA_2 being satisfied (e.g., alone or in combination with one or more other conditions being satisfied and/or unsatisfied). The D_thresholdA_2 and D_thresholdA_1 may have values specific to the second access network and the first access network, respectively, and the values may be same or different.

The condition VAR_1<VAR_thresholdA_1, when satisfied, may indicate (e.g., be an indication) that the first access network may be able to satisfy the requirements of the SDF e.g., for a non-trivial amount of time) and that, alone or in combination with one or more other satisfied and/or unsatisfied conditions, may obviate a need for redundant transmission over the second access network. A WTRU and/or a UPF may trigger and/or carry out a state transition of the dynamic redundant steering mode from active state to inactive state based on the condition VAR_1<VAR_thresholdA_1 being satisfied (e.g., alone or in combination with one or more other conditions being satisfied and/or unsatisfied)

The condition VAR_2<VAR_thresholdA_2, when satisfied, may indicate (e.g., be an indication) that the second access network may be able to satisfy the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition VAR_2<VAR_thresholdA_2 being satisfied (e.g., alone or in combination with one or more other conditions being satisfied and/or unsatisfied). The VAR_thresholdA_2 and VAR_thresholdA_1 may have values specific to the second access network and the first access network, respectively, and the values may be same or different.

The condition L_1>L_thresholdA_1, when satisfied, may indicate (e.g., be an indication) that traffic of an SDF should be removed from the first access network. A WTRU and/or a UPF may trigger and/or carry out a state transition of the dynamic redundant steering mode from active state to inactive state based on the condition L_1>L_thresholdA_1 being satisfied (e.g., alone or in combination with one or more other conditions being satisfied and/or unsatisfied).

The condition L_2>L_thresholdA_2, when satisfied, may indicate (e.g., be an indication) that traffic of an SDF should be removed from the second access network. A WTRU and/or a UPF may trigger and/or carry out a state transition of the dynamic redundant steering mode from active state to inactive state based on the condition L_2>L_thresholdA_2 being satisfied (e.g., alone or in combination with one or more other conditions being satisfied and/or unsatisfied). The L_thresholdA_2 and L_thresholdA_1 may have values specific to the second access network and the first access network, respectively, and the values may be same or different.

The condition PLR_1>PLR_thresholdB_1, when satisfied, may indicate (e.g., be an indication) that redundant transmissions on the first access network are not satisfying the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition PLR_1>PLR_thresholdB_1 being satisfied (e.g., alone or in combination with one or more other conditions being satisfied and/or unsatisfied).

The condition PLR_2>PLR_thresholdB_2, when satisfied, may indicate (e.g., be an indication) that redundant transmissions on the second access network are not satisfying the requirements of an SDF (e.g., for a non-trivial amount of time) and that, alone or in combination with one or more other satisfied and/or unsatisfied conditions, may obviate a need for redundant transmission over the second access network. A WTRU and/or a UPF may trigger and/or carry out a state transition of the dynamic redundant steering mode from active state to inactive state based on the condition PLR_2>PLR_thresholdB_2 being satisfied (e.g., alone or in combination with one or more other conditions being satisfied and/or unsatisfied). The PLR_thresholdB_2 and PLR_thresholdB_1 may have values specific to the second access network and the first access network, respectively, and the values may be same or different.

The condition D_1>D_thresholdB_1, when satisfied, may indicate (e.g., be an indication) that redundant transmissions on the first access network are not satisfying the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition D_1>D_thresholdB_1 being satisfied (e.g., alone or in combination with one or more other conditions being satisfied and/or unsatisfied).

The condition D_2>D_thresholdB_2, when satisfied, may indicate (e.g., be an indication) that redundant transmissions on the second access network are not satisfying the requirements of a SDF (e.g., for a non-trivial amount of time) and that, alone or in combination with one or more other satisfied and/or unsatisfied conditions, may obviate a need for redundant transmission over the second access network. A WTRU and/or a UPF may trigger and/or carry out a state transition of the dynamic redundant steering mode from active state to inactive state based on the condition D_2>D_thresholdB_2 being satisfied (e.g., alone or in combination with one or more other conditions being satisfied and/or unsatisfied). The D_thresholdB_2 and D_thresholdB_1 may have values specific to the second access network and the first access network, respectively, and the values may be same or different.

The condition VAR_1>VAR_thresholdB_1, when satisfied, may indicate (e.g., be an indication) that redundant transmissions on the first access network are not satisfying the requirements of an SDF (e.g., for a non-trivial amount of time) and that, alone or in combination with one or more other satisfied and/or unsatisfied conditions, may obviate a need for redundant transmission over the first access network. A WTRU and/or a UPF may trigger and/or carry out a state transition of the dynamic redundant steering mode from active state to inactive state based on the condition VAR 1>VAR_thresholdB_1 being satisfied (e.g., alone or in combination with one or more other conditions being satisfied and/or unsatisfied).

The condition VAR_2>VAR_thresholdB_2, when satisfied, may indicate (e.g., be an indication) that redundant transmissions on the second access network are not satisfying the requirements of an SDF (e.g., for a non-trivial amount of time) and that, alone or in combination with one or more other satisfied and/or unsatisfied conditions, may obviate a need for redundant transmission over the second access network. A WTRU and/or a UPF may trigger and/or carry out a state transition of the dynamic redundant steering mode from active state to inactive state based on the condition VAR_2>VAR_thresholdB_2 being satisfied (e.g., alone or in combination with one or more other conditions being satisfied and/or unsatisfied). The VAR_thresholdB_2 and VAR_thresholdB_1 may have values specific to the second access network and the first access network, respectively, and the values may be same or different.

The condition L_1<L_thresholdB_1, when satisfied, may indicate (e.g., be an indication) that there is no harm in leaving redundant transmissions over the first access network. A WTRU and/or a UPF might not trigger and/or carry out a state transition of the dynamic redundant steering mode from active state to inactive state based on the condition L_1<L_thresholdB_1 being satisfied (e.g., alone or in combination with one or more other conditions being satisfied and/or unsatisfied).

The condition L_2<L_thresholdB_2, when satisfied, may indicate (e.g., be an indication) that there is no harm in leaving redundant transmissions over the second access network. A WTRU and/or a UPF might not trigger and/or carry out a state transition of the dynamic redundant steering mode from active state to inactive state based on the condition L_1<L_thresholdB_1 being satisfied (e.g., alone or in combination with one or more other conditions being satisfied and/or unsatisfied).

Transitioning the redundant steering mode to inactive may be based on a first link satisfying the requirements of an SDF. In the following, it is assumed that the SDF has requirements for loss, delay, and variability, but it should be understood that these requirements may include any subset of loss, delay, and variability requirements. For example, the SDF may only have a loss requirement, or the SDF may have a loss and delay requirement. In addition to the SDF requirements, the transition may be impacted by a load condition of the second link.

For example, a WTRU and/or a UPF may trigger and/or carry out a state transition of the redundant steering mode to inactive state responsive to, based on, and/or in connection with one of the links satisfying loss, delay, and variability requirements of an SDF. The WTRU and/or the UPF may trigger and/or carry out the state transition, e.g., by satisfying a first triggering condition (“Trigger1”). The Trigger1 may be as follows:

Trigger1: (PLR_1<PLR_thresholdA_1) AND (D_1<D_thresholdA_1) AND
(VAR_1<VAR_thresholdA_1)

As a second example, a WTRU and/or a UPF may trigger and/or carry out a state transition of the redundant steering mode to inactive state responsive to, based on, and/or in connection with one of the links satisfying loss, delay, and variability requirements of an SDF and the other link being congested. The WTRU and/or the UPF may trigger and/or carry out the state transition, e.g., by satisfying a second triggering condition (“Trigger2”). The Trigger2 may be as follows:

Trigger2: (PLR_1<PLR_thresholdA_1) AND (D_1<D_thresholdA_1) AND
(VAR_1<VAR_thresholdA_1) AND (L_2>L_thresholdB_2)

As a third example, a WTRU and/or a UPF may trigger and/or carry out a state transition of the redundant steering mode to inactive state when there is no benefit in having duplication. This may occur when qualities of both links are poor, and even with duplication the system is unable to meet the loss, delay, and/or variability requirements of an SDF. The WTRU and/or the UPF may trigger and/or carry out the state transition, e.g., by satisfying a third triggering condition (“Trigger3”). The Trigger3 may be as follows:

Trigger3: ((PLR_1>PLR_thresholdB_1) OR (D_1>D_thresholdB_1) OR
(VAR_1>VAR_thresholdB_1)) AND ((PLR_2>PLR_thresholdB_2) OR
(D_2>D_thresholdB_2) OR (VAR_2>VAR_thresholdB_2))

A WTRU and/or a UPF may stop (e.g., may need to stop) using one of the legs responsive to, based on, and/or in connection with transitions to an inactive duplication state. As described, the WTRU and/or a UPF may select the leg that satisfies the requirements of an SDF. If both legs can satisfy the requirements of the SDF, the WTRU may choose one leg for operation. Various options are possible for making this choice.

In a first option, the WTRU may choose randomly from the two legs. In a second option, the WTRU may select the leg configured as the primary or initial leg. In a third option, the WTRU may select the leg based on some pre-configured rule (e.g., always select 3GPP or always select non3GPP). In a fourth option, the WTRU may select the leg based on some non-performance metric. For example, it may select based on WTRU power status, user preference, etc. In a fifth option, the WTRU may select the leg based on a default or fallback steering mode. For example, the WTRU may be fallback to active-standby when if both legs can meet the requirements of an SDF.

### Representative Inactive to Active Transitions

A state transition a dynamic redundant steering mode from inactive state to active state may occur, be triggered and/or be carried out based on one or more of various measurements, such as any of the measurements disclosed supra., By way of example, a WTRU and/or a UPF may trigger and/or carry out a state transition of dynamic redundant steering mode from active state to inactive state based on one or more of various measurements, such as, in accordance with FIG. 4 at (416B) and accompanying disclosure.

In various embodiments, the state transition of the dynamic redundant steering mode from active state to inactive state may occur be triggered and/or be carried out responsive to, based on, and/or in connection with any one or combination of various conditions occurring. In the following, it is assumed that the single access used for PDU transmission in the inactive state is the first access network. An equivalent set of conditions and triggers are applicable if the single access used for PDU transmission in the inactive state is the second access network.

The various conditions may include for example, (i) a PLR measurement for the first access network satisfying (e.g., being greater than or equal to) a corresponding fifth of one or more PLR thresholds (denoted herein as “PLR_1>PLR_thresholdB_3”); (ii) a delay measurement for the first access network satisfying (e.g., being greater than or equal to) a corresponding fifth of one or more delay thresholds (denoted herein as “D_1>D_thresholdB_3”); (iii) a variability of delay measurement for the first access network satisfying (e.g., being greater than or equal to) a corresponding fifth of one or more variability of delay thresholds (denoted herein as “VAR_1>VAR_thresholdB_3”); (iv) a PLR measurement for the second access network satisfying (e.g., being less than or equal to) a corresponding sixth of one or more PLR_thresholds (denoted herein as “PLR_2<PLR_thresholdC_1”); (v) a delay measurement for the second access network satisfying (e.g., being less than or equal to) a corresponding sixth of one or more delay thresholds (denoted herein as “D_2<D_thresholdC_1”); (vi) a variability of delay measurement for the second access network satisfying (e.g., being less than or equal to) a corresponding sixth of one or more variability of delay thresholds (denoted herein as “VAR_2<VAR_thresholdC_1”); and (vii) a load measurement for the second access network satisfying (e.g., being less than or equal to) a corresponding fifth of one or more load thresholds (denoted herein as “L_2<L_thresholdB_3”).

The condition PLR_1>PLR_thresholdB_3, when satisfied, may indicate (e.g., be an indication) that transmissions on the first access network are not satisfying the requirements of an SDF (e.g., for a non-trivial amount of time) and that, alone or in combination with one or more other satisfied and/or unsatisfied conditions, may indicate a need for redundant transmissions over the second access network. A WTRU and/or a UPF may trigger and/or carry out a state transition of the dynamic redundant steering mode from inactive state to active state based on the condition PLR_1>PLR_thresholdB_3 being satisfied (e.g., alone or in combination with one or more other conditions being satisfied and/or unsatisfied). The PLR_thresholdB_3 may have a value specific to the first access network and that value may be same as or different from the values for the PLR_thresholdA_2, the PLR_thresholdA_1, the PLR_thresholdB_2 and the PLR_thresholdB_1.

The condition D_1>D_thresholdB_3, when satisfied, may indicate (e.g., be an indication) that transmissions on the first access network are not satisfying the requirements of an SDF and that, alone or in combination with one or more other satisfied and/or unsatisfied conditions, may indicate a need for redundant transmissions over the second access network. A WTRU and/or a UPF may trigger and/or carry out a state transition of the dynamic redundant steering mode from inactive state to active state based on the condition D_1>D_thresholdB_3 being satisfied (e.g., alone or in combination with one or more other conditions being satisfied and/or unsatisfied). The D_thresholdB_3 may have a value specific to the first access network and that value may be same as or different from the values for the D_thresholdA_2, the D_thresholdA_1, the D_thresholdB_2 and the D_thresholdB_1.

The condition VAR_1>VAR_thresholdB_3, when satisfied, may indicate (e.g., be an indication) that transmissions on the first access network are not satisfying the requirements of an SDF (e.g., for a non-trivial amount of time) and that, alone or in combination with one or more other satisfied and/or unsatisfied conditions, may indicate a need for redundant transmissions over the second access network. A WTRU and/or a UPF may trigger and/or carry out a state transition of the dynamic redundant steering mode from inactive state to active state based on the condition VAR_1>VAR_thresholdB_3 being satisfied (e.g., alone or in combination with one or more other conditions being satisfied and/or unsatisfied). The VAR_thresholdB_3 may have a value specific to the first access network and that value may be same as or different from the values for the VAR_thresholdA_2, the VAR_thresholdA_1, the VAR_thresholdB_2 and the VAR_thresholdB 1.

The condition PLR_2<PLR_thresholdC_1, when satisfied, may indicate (e.g., be an indication) that deploying duplication (e.g., transmitting duplicate PDUs) over the second access network may help satisfy the requirements of an SDF. A WTRU and/or a UPF may trigger and/or carry out a state transition of the dynamic redundant steering mode from inactive state to active state based on the condition PLR_2<PLR_thresholdC_1 being satisfied (e.g., alone or in combination with one or more other conditions being satisfied and/or unsatisfied). The PLR_thresholdC_1 may have a value specific to the second access network and that value may be same as or different from the values for the PLR_thresholdA 2, the PLR_thresholdA_1, the PLR_thresholdB_3, the PLR_thresholdB_2 and the PLR_thresholdB_1.

The condition D_2<D_thresholdC_1, when satisfied, may indicate (e.g., be an indication) that deploying duplication (transmitting duplicate PDUs) over the second access network may help satisfy the requirements of an SDF. A WTRU and/or a UPF may trigger and/or carry out a state transition of the dynamic redundant steering mode from inactive state to active state based on the condition D_2<D_thresholdC_1 being satisfied (e.g., alone or in combination with one or more other conditions being satisfied and/or unsatisfied). The D_thresholdC_1 may have a value specific to the second access network and that value may be same as or different from the values for the D_thresholdA 2, the D_thresholdA_1, the D_thresholdB_3, the D_thresholdB_2 and the D_thresholdB_1.

The condition VAR_2<VAR_thresholdC_1, when satisfied, may indicate (e.g., be an indication) that deploying duplication (e.g., transmitting duplicate PDUs) over the second access network may help satisfy the requirements of an SDF. A WTRU and/or a UPF may trigger and/or carry out a state transition of the dynamic redundant steering mode from inactive state to active state based on the condition VAR_2<VAR_thresholdC_1 being satisfied (e.g., alone or in combination with one or more other conditions being satisfied and/or unsatisfied). The VAR_thresholdC_1 may have a value specific to the second access network and that value may be same as or different from the values for the VAR_thresholdA 2, the VAR_thresholdA_1, the VAR_thresholdB_3, the VAR_thresholdB_2 and the VAR_thresholdB_1.

The condition L_2<L_thresholdB_3, when satisfied, may indicate (e.g. be an indication) that the second access network is not congested and/or that, alone or in combination with one or more other satisfied and/or unsatisfied conditions, may indicate that deploying duplication (e.g., transmitting duplicate PDUs) over the second access network may help satisfy the requirements of an SDF. As duplication over the second access network may not significantly impact the load on the second access network, there may be no harm in sending duplicate PDUs over the second access if it may help meet the requirements of an SDF. A WTRU and/or a UPF may trigger and/or carry out a state transition of the dynamic redundant steering mode from inactive state to active state based on the condition L_2<L_thresholdB_3 being satisfied (e.g., alone or in combination with one or more other conditions being satisfied and/or unsatisfied). The L_thresholdB_3 may have a value specific to the first access network and that value may be same as or different from the values for the L_thresholdA_2, the L_thresholdA_1, the L_thresholdB_2 and the L_thresholdB_1. Transitioning the redundant steering mode to active may be based on a first link failing to satisfy the requirements of an SDF. In the following, it is assumed that the SDF has requirements for loss, delay, and variability, but it should be understood that these requirements may include any subset of loss, delay and variability requirements. For example, the SDF may only have a loss requirement, or the SDF may have a loss and delay requirement. In addition to the SDF requirements, the transition may also be impacted by the load condition of the second link.

For example, a WTRU and/or a UPF may trigger and/or carry out a state transition of the redundant steering mode to active state responsive to, based on, and/or in connection with the first access link failing to satisfy the loss, delay, or variability requirements of the SDF. The WTRU and/or the UPF may trigger and/or carry out the state transition, e.g., by satisfying a fourth triggering condition (“Trigger4”). The Trigger4 may be as follows:

Trigger4: (PLR_1>PLR_thresholdB_3) OR (D_1>D_thresholdB_3) OR
(VAR_1>VAR_thresholdB_3)

As a second example, a WTRU and/or a UPF may trigger and/or carry out a state transition of redundant steering mode to active state responsive to, based on, and/or in connection with the first access link failing to satisfy the loss, delay, or variability requirements of the SDF and the other link not being congested. The WTRU and/or the UPF may trigger and/or carry out the state transition, e.g., responsive to, based on, and/or in connection with a fifth triggering condition (“Trigger5”) being satisfied. The Trigger5 may be as follows:

Trigger5: ((PLR_1>PLR_thresholdB_3) OR (D_1>D_thresholdB_3) OR
(VAR_1>VAR_thresholdB_3)) AND (L_2<L_thresholdB_3)

As a third example, a WTRU and/or a UPF may trigger and/or carry out a state transition of the redundant steering mode to active state responsive to, based on, and/or in connection with transmissions on the first access link failing to satisfy the loss, delay, or variability requirements of the SDF and a quality of the second access network enabling the use of the second access network to help in satisfying the requirements of the SDF. The WTRU and/or the UPF may trigger and/or carry out the state transition, e.g., responsive to, based on, and/or in connection with a sixth triggering condition (“Trigger6”) being satisfied In some cases, there may be very little advantage to carrying out a state transition of redundant steering mode to active state and transmitting PDUs over the second access network, if the second access network does not satisfy the loss, delay, or variability requirements of the SDF. An example of Trigger6 may be:

Trigger6: ((PLR_1>PLR_thresholdB_3) OR (D_1>D_thresholdB_3) OR
(VAR_1>VAR_thresholdB_3)) AND ((PLR_2<PLR_thresholdC_1) AND
(D_2<D_thresholdC_1) AND (VAR_2<VAR_thresholdC_1))

Another example of Trigger6 may be:

Trigger6a: (PLR_1>PLR_thresholdB_3) AND
(PLR_thresholdB_3<PLR_2<PLR_thresholdC_1)

A WTRU and/or a UPF may make a decision on a state transition of the redundant steering mode based on a 2-step process. For example, the WTRU and/or the UPF may first determine if duplication over a second access is “needed”, and then may determine if the duplication over the second access is “useful”. In various embodiments, the WTRU and/or the UPF may carry out a state transition of the redundant steering mode from inactive state to active state if (e.g., only if) the duplication is determined to be needed and useful.

The determining of the need for duplication may be based on one or more of the requirements failing to be satisfied. For example, a measured PLR on the first access may be higher than the loss requirement. As another example, a measured delay (e.g., RTT) on the first access may be higher than the delay requirement.

The determining of the usefulness of duplication may be based on one or more (e.g., additional) performance metrics. Examples of the performance metrics include: (i) duplication may be (e.g., only be) useful if a PLR measurement on the second access network satisfies (e.g., is below) a configured threshold (e.g., PLR_thresholdC_1); (ii) duplication may be (e.g., only be) useful if a mean of a delay measurement on the second access network satisfies (e.g., is less) than a threshold (e.g., a D_thresholdD_1); (iii) duplication may be (e.g., only be) useful if a variability of the delay on the second access network is such that a value equal to a mean+a standard deviation of the delay satisfies (e.g., is less) than a threshold (e.g., VAR_thresholdC_1); (iv) duplication may be (e.g., only be) useful if a variability of the delay on the second access network is such that a value equal to a mean+k*standard deviations of the delay satisfies (e.g., is less than) a threshold (e.g., VAR_thresholdC_2); (v) duplication may be (e.g., only be) useful if a variability of the delay on the second access network is such that a value equal to a mean-a standard deviation of the delay satisfies (e.g., is less) than a threshold (e.g., VAR_thresholdC_3); (vi) duplication may be (e.g., only be) useful if a variability of the delay on the second access network is such that a value equal to a mean−k*standard deviation of the delay satisfies (e.g., is less) than a threshold (e.g., VAR_thresholdC_4); (vii) duplication may be (e.g., only be) useful if a variability of the delay on the second access network is such that a value equal to a mean-a standard deviation of delay<a threshold (e.g., VAR_thresholdC_5)<a value equal to a mean+standard deviation of delay; and (viii) duplication may be (e.g., only be) useful if a variability of the delay on the second access network is such that a value equal to a mean−k*standard deviations of delay<a threshold (e.g., VAR_thresholdC_6)<a value equal to a mean+k*standard deviations of delay.

In the above, the value of k and the thresholds may be (pre) configured. These values may be based on the type of application, with some applications having values that will make it less likely that duplication will be determined useful. An AF may provide these values to the network, which may subsequently pass these on to the WTRU in ATSSS rules and to the UPF in N4 rules.

In a first example of the 2-step process, a WTRU and/or a UPF may have a requirement for loss and delay. In a first step, the transmitting entity may determine that one or both of the requirements are not being met on the first access network. For example, the transmitting entity may determine that the PLR may be above a first configured threshold, and/or that the delay may be above a second configured threshold. As a result, the outcome of the first step is that duplication is needed. In a second step, the transmitting entity may compare a variability in the delay on the second access network with a third threshold. In the following, the variability of the delay is defined as a mean+standard deviation (e.g., a value equal to a mean+standard deviation), but it should be understood that it may be any one of the performance metrics described. The transmitting entity may determine that the mean+standard deviation of the delay is larger than the third threshold. This may indicate that for the SDF and for the current conditions on the second access network, duplication is not useful. The transmitting entity may remain in inactive state. Alternatively, the transmitting entity may determine that the mean+standard deviation of the delay may be smaller than the third threshold. This may indicate that for the SDF and for the current conditions on the second access network, duplication is useful. The transmitting entity may transition to active state (and duplicate the packet).

### Other Representative Triggers to State of Redundant Steering Mode

In addition to and/or in lieu of the triggers based on measurements (PLR, D, VAR, L), a WTRU and/or UPF may decide to change the state based on other trigger conditions. These other trigger conditions may be combined (e.g., used together) with the triggers based on measurements. By way of example, a WTRU and/or a UPF may trigger and/or carry out a state transition of dynamic redundant steering mode (such as in accordance with FIG. 4, at (416A) and/or (416B) and accompanying disclosure) based on one or more of various measurements, triggers based on measurements and/or the other trigger conditions.

In a first of the other trigger conditions for changing a state of the redundant steering mode, a battery status of the WTRU may trigger a change of state. For example, if the battery status is low, a WTRU may want to limit operation to a single access network so that it may shut down the second access network. In such a case, if the battery status is below a configured threshold, this may trigger the WTRU to change state from active to inactive. The WTRU may also have rules to help it choose the access network to use in the inactive state based on the access that uses less power.

In a second of the other trigger conditions to change a state of the redundant steering mode, a mobility event at a WTRU may trigger change of state from inactive to active. During a 5G handover, there is an interruption time while the WTRU is trying to switch to a target cell and during which the WTRU may not use its 3GPP access network. For multi-access PDU sessions with redundant steering mode, the second access network, over the non-3GPP access, may be used during this interruption time. One or more of the following may trigger transition from inactive to active: (i) a WTRU sending a measurement report to the source gNB (e.g., this may be for events: A2, A3, A4, A5, A6, B1, B2), and (ii) a WTRU receiving a RRC Reconfiguration message carrying/indicating a configuration for the target cell.

After the redundant transmissions are no longer needed to address the mobility event, the redundant steering mode may transition back to inactive. One or more of the following may trigger transition back to inactive: (i) a WTRU hands over to the target cell and sends RRC Reconfiguration Complete message to the target gNB, and (ii) a WTRU sending a measurement report to the source gNB (e.g., this may be for event: A1).

In a third of the other trigger conditions to change state of redundant steering mode, a WTRU may trigger change of state from inactive to active (or from active to inactive) for uplink transmissions based on an indication from the network. The indication, for example, may be from the UPF. The UPF may send the indication to the WTRU to change state, and if transitioning to inactive, the UPF may also indicate which access to use.

In a fourth of the other trigger conditions to change state of redundant steering mode, a UPF may trigger change of state from inactive to active (or from active to inactive) for downlink transmissions based on an indication from the WTRU. For example, the WTRU may send an indication to the UPF to change state, and if transitioning to inactive, the WTRU may also indicate which access to use. The communication (e.g., signaling) of the indication between the WTRU and UPF may be carried out using PMF messages. The messages may include a QoS flow ID, SDF ID, and/or a requested state change for the redundant steering mode.

In a fifth of the other trigger conditions to change state of redundant steering mode, a WTRU may trigger change of state from active to inactive responsive to, based on and/or in connection with a path switch on the non3GPP access network. 5G systems may support a multi-access PDU session with traffic switching between one non-3GPP access network path, from a WTRU to a N3IWF in a PLMN, and another non-3GPP access network path, from the WTRU to a TNGF in the same PLMN. In such cases, the WTRU and UPF may have 3 access legs temporarily for use: a first over 3GPP, a second over non3GPP towards a N3IWF, and a third over non3GPP towards a TNGF. If duplication is active during this time, the WTRU and UPF may have various option.

In a first of the options, the WTRU and/or UPF may decide to deactivate the duplication (transition to inactive) and use only the 3GPP access leg. The WTRU and/or UPF may return to active state when the WTRU has completed its path switch on the non3GPP access.

In a second of the options, the WTRU and/or UPF may decide to use only one of the non3GPP access legs for duplication. The choice of which non3GPP access leg may be used may be based on a configuration, e.g., received during establishment and/or one or more modifications of multi-access PDU session. The choice of which non3GPP access leg may be based on performance measurements over the two non3GPP access legs. For example, if one leg meets the PLR criteria and the other does not, then the WTRU or UPF may decide to favor the leg that meets the PLR criteria. The choice of which non3GPP access leg may be based on implementation or may be randomly selected by the WTRU and/or the UPF. The choice of which non3GPP access leg may be pre-configured (e.g., semi statically and/or dynamically via any of layer 1 (L1), layer 2 (L2), layer 3 (L3) and/or higher layer communications including, for example, one or more transmissions that may carry MAC, RRC, and/or other messages and/or information). For example, for a path switch from a source non3GPP leg to a target non3GPP leg, the WTRU and UPF may always use the source non3GPP leg, or they may always use the target non3GPP leg.

In a sixth of the trigger conditions to change state of redundant steering mode, a WTRU may trigger change of state from inactive to active responsive to, based on and/or in connection with is a path switch on the 3GPP access network. 5G systems support traffic switching on a 3GPP access path, from a WTRU using a direct path to a gNB to a WTRU using an indirect path to the gNB (i.e., through a relay device). During the path switch, there is an interruption time during which the WTRU may not use its 3GPP access network. For the multi-access PDU sessions with redundant steering mode, the second access network, over the non-3GPP access, may be used during this interruption time. A path switch may be used as a trigger to transition from inactive to active.

In a seventh of the other trigger conditions to change state of redundant steering mode, a WTRU may trigger change of state from inactive to active responsive to, based on and/or in connection with a pending radio link failure on the 3GPP path. The WTRU is always monitoring RLF failure conditions (e.g., based on physical layer issues). When the WTRU detects that a radio link failure on the 3GPP path is pending, it may decide to trigger a transition to active redundant steering mode to allow some connectivity between the WTRU and UPF.

In an eighth of the other trigger conditions to change state of redundant steering mode, a WTRU may trigger change of state from active to inactive based on overheating status. WTRUs monitor overheating status and can inform the gNB when an overheating condition is met. If redundant steering mode is active for a WTRU, and the WTRU detects an overheating condition, the WTRU may decide to transition to inactive status. For example, this may help reduce the power or may allow the WTRU to turn off radio components corresponding to the non3GPP access network.

In a ninth of the other trigger conditions to change state of redundant steering mode, a WTRU may trigger change of state from active to inactive (and vice versa) based on an indication from the user provided through a user interface. A user may decide to force the WTRU to activate duplication or deactivate duplication.

In a tenth of the other trigger conditions to change state of redundant steering mode, the WTRU and/or the UPF may be provided with a schedule to activate or deactivate duplication. The network may determine the schedule based on inputs from the WTRU, one or more application servers, one or more RAN nodes, NWDAF, etc. The schedule may be provided to the WTRU and/or the UPF (e.g., semi statically and/or dynamically via any of L1, L2, L3, etc., communications including, for example, one or more transmissions that may carry MAC, RRC, and/or other messages and/or information). The WTRU and/or UPF may activate and deactivate duplication based on the schedule. A WTRU may know from its traffic profile that it will generate traffic that is very periodic. For example, the WTRU may know that every 100 msec, the application generates one packet that requires very high throughout and low latency. For such an example, the WTRU may configure a schedule such that duplication is active for 10 msec every 100 msec.

In an eleventh of the other trigger conditions to change state of redundant steering mode, the WTRU and/or the UPF may trigger a change in state based on the other steering modes that are enabled for other SDFs between the WTRU and/or the UPF. For example, the WTRU and/or the UPF may be configured to deactivate duplication if there are no other steering modes enabled, or the WTRU and UPF may be configured to activate duplication if the WTRU is already using the non3GPP path for another steering mode.

### Representative Communication of State Change of Redundant Steering Mode

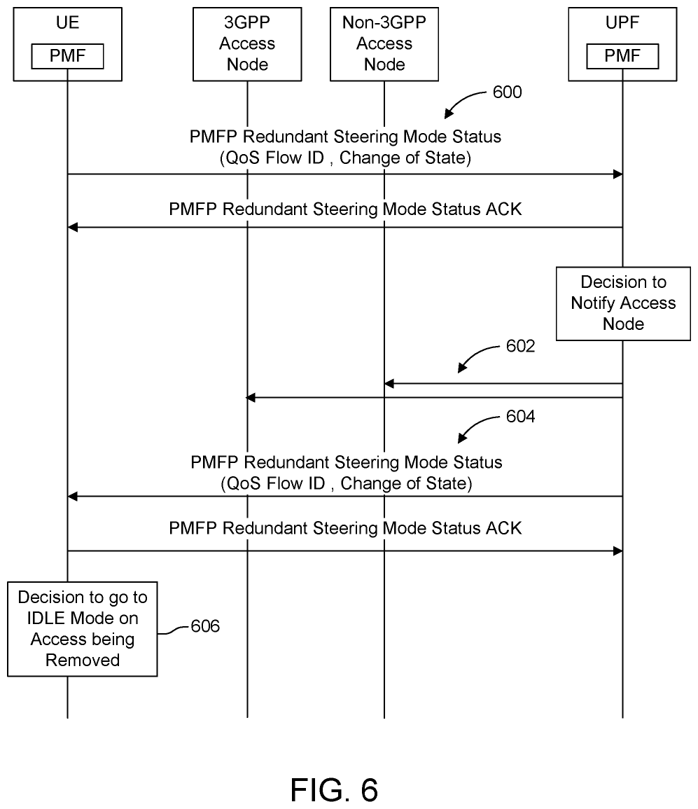

Referring to FIG. 6, when a WTRU (or UPF) changes the state of the redundant steering mode, it may be useful to inform the peer entity (UPF (or WTRU)) about the change of state. The exchange of communication (600) (e.g., exchange of signaling) between the WTRU and the UPF may be carried out via any of L1, L2, L3, etc. communications, including, for example, one or more transmissions that may carry MAC, RRC, and/or PMF messages. The PMF messages may include a QoS flow ID, a service data flow ID, active or inactive status of the redundant steering mode and/or an indication to suspend duplication (inactive) and resume duplication (active status). After and/or responsive to receiving the PMF message from a WTRU, the UPF may notify impacted access network nodes (602). After and/or responsive to receiving the PMF message from a UPF (604), the WTRU may take any of the following actions: (i) stop making measurements on any access networks that are removed, and (ii) enter IDLE mode (606), if needed, on any access network that are removed.

A duration may also be specified in the PMF messages. This duration may indicate for how long the transition to inactive or active (or vice-versa) should be applied. For example, if the WTRU is doing a 5G handover and redundancy is needed for a short period of time, a duration (e.g., 3 seconds) may be specified. In this case, the WTRU and/or the UPF switch back to inactive after the 3 seconds. The same access network that was used before the quick switch to active is re-used with the inactive mode.

More generally, when a WTRU (or UPF) changes the state of the redundant steering mode, it may be useful to inform the peer entity (UPF (or WTRU)) about the change of state using any of L1, L2, L3, etc. communications, e.g., in one or more signaling messages. The signaling messages may include one or more of the following: (i) information indicating a PDU Session ID, (ii) information indicating one or more QoS Flow IDs, (iii) information indicating one or more SDF IDs, (iv) information indicating an active or inactive status of the redundant steering mode, (v) information indicating a duration for a state (“state duration”) of the redundant steering mode (e.g., one for a single state or one for each state), (vi) information indicating a schedule for carrying out duplication (“duplication schedule”), (vii) information indicating one or more triggers that resulted in the change in state, and (viii) an indication and/or information indicating a request that the return link from a peer may change duplication state.

The active or inactive status of the redundant steering mode may be provided per PDU session, per QoS flow, or per SDF, for example.

Each state duration of the redundant steering mode may indicate for how long the redundant steering mode is to remain in an inactive or an active state, e.g., following a state transition to inactive or active (or vice-versa). By way of example, a WTRU may be engaged in a 5G handover and redundancy may be needed for a time period (e.g., a short time period). A state duration (e.g., 3 seconds) for an active (or next occurring) state may be specified for this purpose. The WTRU and a UPF may switch the redundant steering mode back to inactive after the 3 seconds. The same access network that was used before the quick switch to active may be re-used with the inactive mode.

The duplication schedule may be based on the traffic profile that may have been determined by a WTRU or a UPF. The WTRU (or UPF) may provide this schedule to the UPF (or WTRU). The duplication schedule may indicate one or more time periods during which the redundant steering mode is to be in an active state. The WTRU and the UPF may switch the redundant steering mode to and from the active state in accordance with the schedule (e.g., carry out the switching so as to be in the active state for the entire duration of each time period or start the switching at the leading and trailing ends of each time period).

The triggers that resulted in the change in state may be determined by a WTRU (or a UPF). The WTRU (or UPF) may inform its peer (UPF (or WTRU)) of the triggers that resulted in a change of state. The change of state may be a result of any of the: user indication, overheating, pending RLF, upcoming handover, performance metric (such as PLR, Delay, variability of delay, access load) etc.

The indication and/or the information indicating a request that the return link from a peer change duplication state may be used, e.g., when the uplink and downlink may not be in the same redundant steering mode state. For example, the uplink may have duplication active, but the downlink may have duplication inactive. The request that the return link from a peer change duplication state may be for use cases where the 3GPP path uses frequency division duplexing (FDD), and as a result, has different performance metrics for the uplink and downlink. In such cases, the sending entity (WTRU or UPF) on the forward link, may inform the receiving entity (UPF or WTRU) that the state should be changed for the return link. The signaling message may inform the peer entity to use the same duplication state as the forward link, or it may specify a specific duplication state to use for the return link.

Hereinafter, for ease of presentation, it is assumed that the above information is included in a duplication state (DS) information element (IE) that is carried in one or more (e.g., signaling) messages. This should be taken as an exemplary implementation. It should be understood that only a subset of the above information may be included in the DS IE, or that the information may be included in multiple IEs.

The communications (e.g., signaling) between the WTRU and the UPF may be carried out via any of L1, L2, L3, etc. communications, including, for example, one or more transmissions that may carry MAC, RRC, and/or PMF messages and/or information. A new PMF message may be defined to carry this information (e.g., PMFP DUPLICATION STATE). This message may be bi-directional (WTRU to UPF and UPF to WTRU). Alternatively, an IE may be included in an existing PMF message (such as PMFP ACCESS REPORT or PMFP UAD PROVISIONING). As these messages are unidirectional, they may be redefined to be bidirectional. As a third alternative, the IE may be included in an existing PMF message (such as PMFP ACCESS REPORT or PMFP UAD PROVISIONING) for the WTRU to UPF direction, and equivalent PMF messages are defined for the UPF to WTRU direction such as PMFP ACCESS REPORT1 or PMFP UAD PROVISIONING1. In cases where the WTRU and UPF have a QUIC connection (e.g., a MASQUE connection over QUIC), the signaling between the WTRU and UPF may be done through QUIC messages. A DS IE may be added in a QUIC message (e.g., a CAPSULE protocol message sent over the MASQUE connection). The client (e.g., WTRU) sets this IE in the CAPSULE protocol message sent in a QUIC packet to the server (e.g., proxy).

In cases where the WTRU and UPF have a DCCP connection, the DS IE may be added as a new DCCP option in a DCCP request/response message.

After and/or responsive to receiving the signaling message from a WTRU, a UPF may perform one or more of the following: (i) notify the impacted access nodes about the legs that are activated or the legs that are deactivated, (ii) activate or deactivate duplication based on the request in the signaling message, (iii) store the duplication schedule and transition from active to inactive and from inactive to active according to the received schedule, (iv) store the duration of a state transition and transition from active to inactive or from inactive to active, accordingly, and (v) notify the AF about a change in duplication state of the redundant steering mode.

After and/or responsive to receiving the signaling message from a UPF, a WTRU may carry out one or more of the following actions: (i) if redundant steering mode is becoming inactive and an access network is being removed, the WTRU may stop taking measurements on any access network that are removed, (ii) if redundant steering mode is becoming active and an access network is being added, the WTRU may (re) start taking measurements on any access network that are added, (iii) _if redundant steering mode is becoming inactive and an access network is being removed, and there are no other SDFs over the removed access network, the WTRU may stop reception processing on the removed access, (iv) if redundant steering mode is becoming active and an access network is being added, and there are no existing SDFs over the access to be added, the WTRU starts reception processing on the added access, (v) if redundant steering mode is becoming inactive and an access network is being removed, and there are remaining SDFs over the removed access network, the WTRU may discard any duplicate packets received on the removed access network, (vi) the WTRU may discard any duplicate packets received on the removed access network at the ATSSS layer, (vii) if redundant steering mode is becoming active and an access network is being added, and there are existing SDFs over the access network that is being added, the WTRU may (re) start processing duplicate packets at the ATSSS layer, (viii) the WTRU may use different measurement criteria on the accesses, (ix) if the UPF notifies the WTRU that redundant steering mode is now inactive and that a non3GPP path is removed, the WTRU may start taking more measurements on the 3GPP path to more quickly determine when redundant steering mode should become active again, (x) the WTRU may activate or deactivate duplication based on the request in the signaling message, (xi) the WTRU may store the duplication schedule and transition from active to inactive and from inactive to active according to the received schedule, (xii) the WTRU may store the duration of a state transition and transition from active to inactive or from inactive to active, accordingly, (xiii) the WTRU may transition to IDLE mode, if needed, on the access networks that are removed.

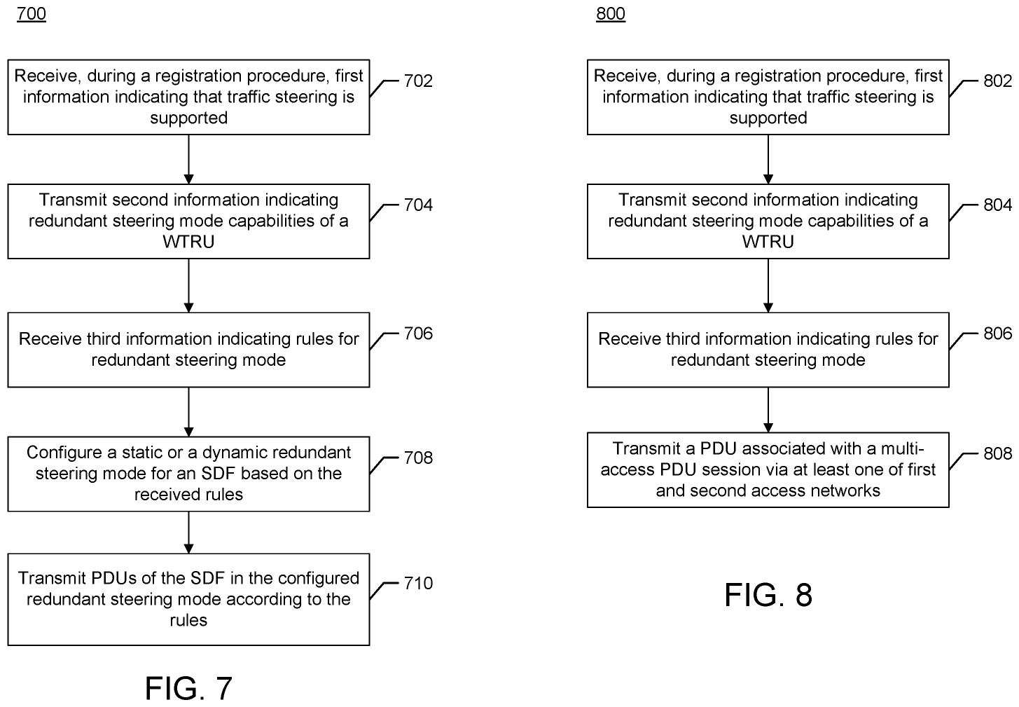

FIG. 7 is a flow chart illustrating an example flow 700 for use in connection with a multi-access PDU session establishment and/or modification. The flow 700 and accompanying disclosures herein may be considered a generalization of at least some of the disclosures accompanying FIGS. 4-6, and are considered to encompass and/or include various embodiments of the disclosures above, including, for example, at least some of the disclosures accompanying FIGS. 4-6. The flow 700 may be carried out using the architecture of the communications system 100 of FIGS. 1A-1D. The flow 700 may be carried out using other architectures as well.

Referring to FIG. 7, a WTRU may receive, via a first network element during a registration procedure, first information indicating that traffic steering is supported (702). In various embodiments, the first network element may be, for example, an AMF. In various embodiments, the first information may include a multi-access PDU session support indicator.

The WTRU may transmit, to a first network element, second information that may indicate one or more redundant steering mode capabilities of the WTRU (704). In various embodiments, the redundant steering mode capabilities of the WTRU may be or include ATSSS capabilities. In various embodiments, the ATSSS capabilities (the redundant steering mode capabilities) may include any of support for redundant traffic steering mode, support for duplicated detection, support for a specific steering functionality. In various embodiments, the second information may indicate one of a request to establish a multi-access protocol PDU session or a request to modify a multi-access PDU session. As an example, the second information may be a PDU session establishment request, or a PDU session modification request, having information regarding redundant steering mode capabilities of the WTRU.

The WTRU may receive, e.g., via a second network element, third information, wherein the third information may indicate one or more rules for redundant steering mode (706). In various embodiments, the third information may indicate a response to the one of the request to establish a multi-access PDU session or a request to modify a multi-access PDU. As an example, the third information may be a PDU session establishment request acceptance message having information regarding (e.g., indicating) at least one of ATSSS rules for redundant steering mode and other rules for redundant steering mode. In various embodiments, the WTRU may expect to receive information indicating at least one rule for redundant steering mode based on transmitting the first information indicating the one or more redundant steering mode capabilities of the WTRU.

The WTRU may configure a static or a dynamic redundant steering mode for an SDF based on the received rules (708). The WTRU may transmit one or more PDUs of the SDF in a configured redundant steering mode according to the rules (e.g., at least one of the ATSSS rules or the other rules) (710),

In various embodiments, the redundant steering rules may include information indicating that the redundant steering mode may be “static” or “dynamic”. In various embodiments, receiving information indicating whether (or that) performing duplicate detection and discard is a requisite for the ATSSS-LL steering functionality.

In various embodiments, the dynamic steering mode is configured, and the redundant steering rules (e.g., ATSSS rules) may include information indicating whether an initial state of the steering mode may be active or inactive. If inactive, the initial PDU transmissions of the service data flow may over the 3GPP access or the non-3GPP access.

In various embodiments, dynamic steering mode is configured, and a measurement configuration includes thresholds for one or more of: PLR, delay, variability of delay, access load, etc. In various embodiments, inactive to active transitions occur only when a single access cannot meet all the requirements of the SDF, and using both accesses can meet all the requirements of the SDF. This decision may be based on a combination of conditions related to PLR on each access, delay on each access, variability of delay on each access, and load on each access.

In various embodiments, active to inactive transitions may occur only when a single access can met all the requirements of the SDF. This decision may be based on a combination of conditions related to PLR on each access, Delay on each access, variability of delay on each access, and load on each access.

In various embodiments where dynamic steering mode is configured, transitions may occur based on one or more of the following: UE battery status, mobility event, based on an message from the network. In various embodiments, a message from the network may include a state duration. In various embodiments, if the transition is to inactive, the message from the network may contain an indication of which access to use.

FIG. 8 is a flow chart illustrating an example flow 800 according to various embodiments. The flow 800 and accompanying disclosures herein may be considered a generalization of at least some of the disclosures accompanying FIGS. 4-6, and are considered to encompass and/or include various embodiments of the disclosures above, including, for example, at least some of the disclosures accompanying FIGS. 4-7. The flow 800 may be carried out using the architecture of the communications system 100 of FIGS. 1A-1D. The flow 800 may be carried out using other architectures as well.

Referring to FIG. 8, a WTRU may receive, from a network element during a registration procedure, first information indicating that traffic steering is supported (802). In various embodiments, the first network element may be, for example, an AMF. In various embodiments, the first information may be or include a multi-access PDU session support indicator.

The WTRU may transmit, to a first network element, second information that may indicate one or more redundant steering mode capabilities of the WTRU (804). In various embodiments, the redundant steering mode capabilities of the WTRU may be or include ATSSS capabilities. In various embodiments, the ATSSS capabilities (the redundant steering mode capabilities) may include any of support for redundant traffic steering mode, support for duplicated detection, support for a specific steering functionality. In various embodiments, the second information may indicate one of a request to establish a multi-access protocol PDU session or a request to modify a multi-access PDU session. As an example, the second information may be a PDU session establishment request, or a PDU session modification request, having information regarding redundant steering mode capabilities of the WTRU.

The WTRU may receive, e.g., via a second network element, third information, wherein the third information may indicate one or more rules for redundant steering mode (806). In various embodiments, the third information may indicate a response to the one of the request to establish a multi-access PDU session or a request to modify a multi-access PDU. As an example, the third information may be a PDU session establishment request acceptance message having information regarding (e.g., indicating) at least one of ATSSS rules for redundant steering mode and other rules for redundant steering mode. In various embodiments, the WTRU may expect to receive information indicating at least one rule for redundant steering mode based on transmitting the first information indicating the one or more redundant steering mode capabilities of the WTRU.

The WTRU may transmit a PDU associated with the multi-access PDU session via at least one of first and second access networks (808), wherein: (i) the PDU is transmitted via the first and second access networks based on a first of the rules and first values of two or more metrics associated with each of the first and second access networks, and (ii) the PDU is transmitted via one of the first and second access networks based on a second of the rules and second values of two or more metrics associated with each of the first and second access networks.

In various embodiments, at least one of the one or more rules indicates PDU duplication for the redundant steering mode is inactive (or active), and the WTRU may be configured to transmit the PDU based on the indicated PDU duplication based on lacking any value for one or more of the metrics associated with each of the first and second access networks. In various embodiments, the first rule may indicate to use the first and second access networks on condition that neither (i) the first values of the two or more metrics associated with the first access network nor (ii) the first values of the two or more metrics associated with the second access network satisfy respective thresholds.

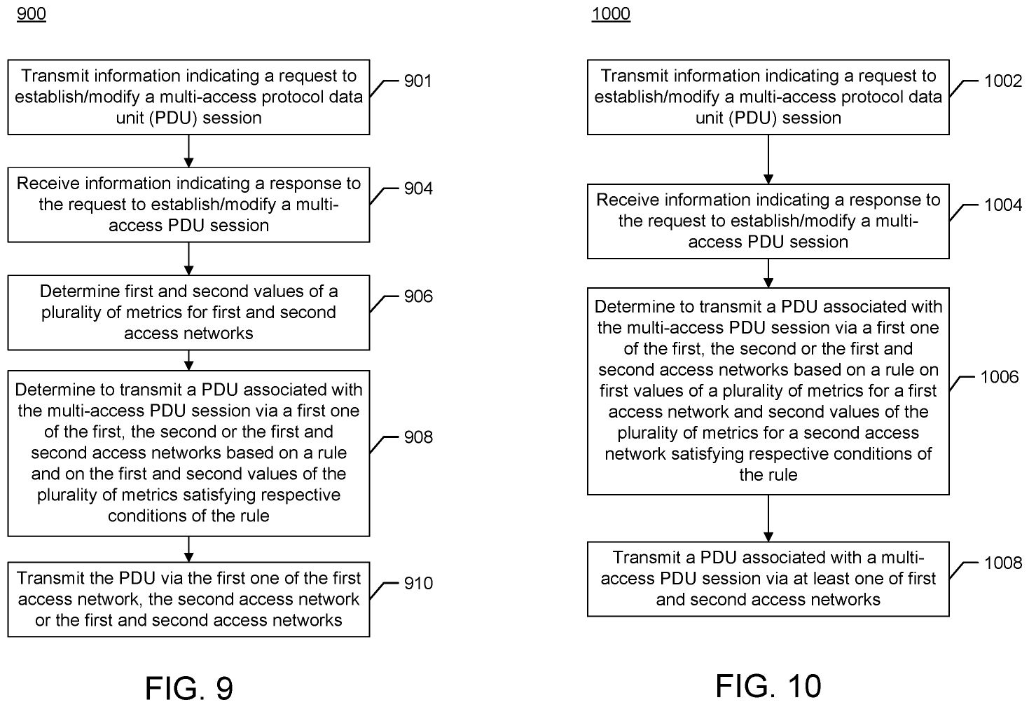

FIG. 9 is a flow chart illustrating an example flow 900 according to various embodiments. The flow 900 and accompanying disclosures herein may be considered a generalization of at least some of the disclosures accompanying FIGS. 4-6, and are considered to encompass and/or include various embodiments of the disclosures above, including, for example, at least some of the disclosures accompanying FIGS. 4-8. The flow 900 may be carried out using the architecture of the communications system 100 of FIGS. 1A-1D. The flow 900 may be carried out using other architectures as well.

Referring to FIG. 9, a WTRU may transmit, to a first network element, first information indicating one of a request to establish a multi-access PDU session or a request to modify a multi-access PDU session (902). The WTRU may receive, via a second network element, second information indicating a response to the one of the request to establish a multi-access PDU session or a request to modify a multi-access PDU session (904). The WTRU may determine first values of a plurality of metrics for a first access network (906). The WTRU may determine second values of the plurality of metrics for a second access network (906). The WTRU may determine to transmit a PDU associated with the multi-access PDU session via a on of (i) the first access network, (ii) the second access network or (iii) the first and second access networks based on a rule for redundant steering mode and on the first and second values of the plurality of metrics satisfying respective conditions of the rule (908). The WTRU may transmit the PDU via the on of the first access network, the second access network or the first and second access networks.

In various embodiments, the PDU is a PDU of an SDF associated with the multi-access PDU session. In various embodiments, based on the rule. a state transition of the redundant steering mode from inactive to active is carried out on condition that only a single one of the first and second access networks cannot satisfy requirements of the SDF. In various embodiments, based on the rule. a state transition of the redundant steering mode from active to inactive is carried out on condition that only a single one of the first and second access networks can satisfy requirements of the SDF.

In various embodiments, information indicating a duration for a state of the redundant steering mode is received from the network. In various embodiments, information indicating which of the first or second access network to use is received for the duration. In various embodiments, measurements on any of the first and second access networks that are removed are paused for the duration. In various embodiments, the WTRU transitions to IDLE mode on the accesses that are removed for the duration.

In various embodiments, the first information indicates one or more redundant steering mode capabilities of the WTRU, and wherein the second information indicates one or more rules for redundant steering mode, including the rule.

In various embodiments, the plurality of metrics network element is an access and mobility management function. In various embodiments, the second network element is a base station. In various embodiments, the second network element is a base station associated with a second, different than the first, one of the first access network, the second access network or the first and second access networks.

In various embodiments, the plurality of metrics comprises any two of a packet loss rate, a delay, a variability of delay and load.

In various embodiments, the one or more rules for redundant steering mode include information indicating that an initial state of the redundant steering mode is one of active and inactive. In various embodiments, initial PDU transmissions of the SDF are transmitted over the one of the first access network, the second access network or the first and second access networks based on the initial state of the redundant steering mode being one of active and inactive.

In various embodiments, the one or more rules comprises information indicating a measurement configuration for the plurality of metrics. In various embodiments of the apparatus, wherein circuitry is configured to expect to receive information indicating at least one rule for redundant steering mode based on transmitting the first information indicating the one or more redundant steering mode capabilities of the WTRU. In various embodiments of the methods, the method may include expecting to receive information indicating at least one rule for redundant steering mode based on transmitting the first information indicating the one or more redundant steering mode capabilities of the WTRU.

In various embodiments of the methods, the method may receive, via the second network element during a registration procedure, third information indicating that traffic steering is supported. In various embodiments of the methods, determining to transmit a PDU may include determining to transmit a PDU via the first and second access networks based on the rule, on the first and second values of the plurality of metrics satisfying respective conditions of the rule, and on the rule indicating PDU duplication for the redundant steering mode is inactive, and transmitting the PDU may include transmitting the PDU based on the indicated PDU duplication.

In various embodiments of the apparatus, the circuitry being configured to determine to transmit or receive a PDU comprises the circuitry being configured to: determine to transmit a PDU via the first and second access networks based on the rule, on the first and second values of the plurality of metrics satisfying respective conditions of the rule, and on the rule indicating PDU duplication for the redundant steering mode is inactive, and the circuitry being configured to transmit the PDU comprises the circuitry being configured to: transmit the PDU based on the indicated PDU duplication.

FIG. 10 is a flow chart illustrating an example flow 1000 according to various embodiments. The flow 1000 and accompanying disclosures herein may be considered a generalization of at least some of the disclosures accompanying FIGS. 4-6, and are considered to encompass and/or include various embodiments of the disclosures above, including, for example, at least some of the disclosures accompanying FIGS. 4-8. The flow 1000 may be carried out using the architecture of the communications system 100 of FIGS. 1A-1D. The flow 1000 may be carried out using other architectures as well.

Referring to FIG. 10, A WTRU may transmit, to a first network element, first information indicating one of a request to establish a multi-access protocol data unit (PDU) session or a request to modify a multi-access PDU session (1002). The WTRU may receive, via a second network element, second information indicating a response to the one of the request to establish a multi-access PDU session or a request to modify a multi-access PDU session (1003). The WTRU may determine to transmit or to receive a PDU associated with the multi-access PDU session via a on of (i) the first access network, (ii) the second access network or (iii) the first and second access networks based on a rule for redundant steering mode, on first values of a plurality of metrics for a first access network and second values of the plurality of metrics for a second access network satisfying respective conditions of the rule (1006). The WTRU may perform one of transmitting and receiving the PDU via the on of the first access network, the second access network or the first and second access networks.

In various embodiments, the PDU is a PDU of an SDF associated with the multi-access PDU session. In various embodiments, based on the rule. a state transition of the redundant steering mode from inactive to active is carried out on condition that only a single one of the first and second access networks cannot satisfy requirements of the SDF. In various embodiments, based on the rule. a state transition of the redundant steering mode from active to inactive is carried out on condition that only a single one of the first and second access networks can satisfy requirements of the SDF.

In various embodiments, information indicating a duration for a state of the redundant steering mode is received from the network. In various embodiments, information indicating which of the first or second access network to use is received for the duration. In various embodiments, measurements on any of the first and second access networks that are removed are paused for the duration. In various embodiments, the WTRU transitions to IDLE mode on the accesses that are removed for the duration.

In various embodiments, the first information indicates one or more redundant steering mode capabilities of the WTRU, and wherein the second information indicates one or more rules for redundant steering mode, including the rule.

In various embodiments, the plurality of metrics network element is an access and mobility management function. In various embodiments, the second network element is a base station. In various embodiments, the second network element is a base station associated with a second, different than the first, one of the first access network, the second access network or the first and second access networks.

In various embodiments, the plurality of metrics comprises any two of a packet loss rate, a delay, a variability of delay and load.

In various embodiments, the one or more rules for redundant steering mode include information indicating that an initial state of the redundant steering mode is one of active and inactive. In various embodiments, initial PDU transmissions of the SDF are transmitted over the one of the first access network, the second access network or the first and second access networks based on the initial state of the redundant steering mode being one of active and inactive.

In various embodiments, the one or more rules comprises information indicating a measurement configuration for the plurality of metrics. In various embodiments of the apparatus, wherein circuitry is configured to expect to receive information indicating at least one rule for redundant steering mode based on transmitting the first information indicating the one or more redundant steering mode capabilities of the WTRU. In various embodiments of the methods, the method may include expecting to receive information indicating at least one rule for redundant steering mode based on transmitting the first information indicating the one or more redundant steering mode capabilities of the WTRU.

In various embodiments of the methods, the method may receive, via the second network element during a registration procedure, third information indicating that traffic steering is supported. In various embodiments of the methods, determining to transmit a PDU may include determining to transmit a PDU via the first and second access networks based on the rule, on the first and second values of the plurality of metrics satisfying respective conditions of the rule, and on the rule indicating PDU duplication for the redundant steering mode is inactive, and transmitting the PDU may include transmitting the PDU based on the indicated PDU duplication.

In various embodiments of the apparatus, the circuitry being configured to determine to transmit or receive a PDU comprises the circuitry being configured to: determine to transmit a PDU via the first and second access networks based on the rule, on the first and second values of the plurality of metrics satisfying respective conditions of the rule, and on the rule indicating PDU duplication for the redundant steering mode is inactive, and the circuitry being configured to transmit the PDU comprises the circuitry being configured to: transmit the PDU based on the indicated PDU duplication.

The following references may have been referred to hereinabove and are incorporated in full herein by reference.
RFC8684, TCP Extensions for Multipath Operation with Multiple Addresses;
, Service requirements for the 5G system, 3GPP TS 22.261 V18.5.0;
3GPP; Technical Specification Group Services and System Aspects; Procedures for the 5G System (5GS); Stage 2, (Release 17), 3G TS 23.502 v17.3.0;
3rd Generation Partnership Project (“3GPP”); Technical Specification Group Services and System Aspects; System architecture for the 5G System (5GS); Stage 2, (Release 17), 3GPP TS 23.501 v17.3.0;
, Study on access traffic steering, switch and splitting support in the 5G System (5GS) architecture, 3GPP TRS 23.700-93 V17.0.0; and
SP-211612, New SID on Access Traffic Steering, Switching and Splitting support in the 5G system architecture; Phase 3, SP-94E, 14-20 Dec. 2021.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1.-26. (canceled)

27. A device supporting access traffic steering, switching, and splitting (ATSSS), the device comprising:
a transceiver; and
a processor; wherein:
the transceiver is configured to receive information to establish a multi-access protocol data unit (PDU) session, including first indication information for first ATSSS rules for a first redundant steering mode (RSM);
the transceiver and the processor are configured to, based on the first ATSSS rules for the first RSM:
duplicate a first PDU, and
transmit the duplicated first PDU on both a first access network and a second access network;
the transceiver is configured to receive information to modify the PDU session, including second indication information for second ATSSS rules for a second RSM, wherein the second indication information for second ATSSS rules for the second RSM includes configured thresholds; and
the transceiver and the processor are configured to, based on the second ATSSS rules for the second RSM:
measure performance metrics for the first access network;
measure performance metrics for the second access network; and
on a condition that the measured performance metrics for both the first access network and the second access network do not satisfy the configured thresholds:
duplicate a second PDU; and
transmit the duplicated second PDU on both the first access network and the second access network.

28. The device of claim 27, wherein the transceiver and the processor are further configured to:
on a condition that the measured performance metrics for the first access network satisfy the configured thresholds and the measured performance metrics for the second access network do not satisfy the configured thresholds:
select the first access network; and
transmit the second PDU on the selected first access network.

29. The device of claim 27, wherein the transceiver and the processor are further configured to:
on a condition that the measured performance metrics for the second access network satisfy the configured thresholds and the measured performance metrics for the first access network do not satisfy the configured thresholds:
select the second access network; and
transmit the second PDU on the selected second access network.

30. The device of claim 27, wherein the transceiver and the processor are further configured to:
select an access network on a condition that the measured performance metrics for both the first access network and the second access network satisfy the configured thresholds; and
transmit the second PDU on the selected access network.

31. The device of claim 30, wherein the selected access network is one of the first access network or the second access network.

32. The device of claim 31, wherein the selected access network is an initial access network included in the second ATSSS rules for the second RSM.

33. The device of claim 27, wherein the first RSM is static and the second RSM is dynamic.

34. The device of claim 27, wherein the first ATSSS rules for the first RSM do not include configured thresholds.

35. The device of claim 27, wherein the device is a wireless transmit/receive unit (WTRU); and wherein:
the transceiver is further configured to receive, from an access and mobility management function (AMF) during a registration procedure, third information indicating that ATSSS is supported;
the transceiver and processor are further configured to transmit, to the AMF, fourth information indicating (i) a request to establish a multi-access PDU session and (ii) RSM capabilities of the WTRU; wherein the received information to establish a multi-access PDU session is included in a response to the transmitted request;
the transceiver is further configured to receive, from a user plane function (UPF), a performance management function (PMF) message; and
the transceiver and processor are further configured to at least one of suspend PDU duplication based on the received PMF message, or resume PDU duplication based on the received PMF message.

36. The device of claim 27, wherein the device is a UPF; and wherein:
the processor is further configured to determine to at least one of suspend PDU duplication or resume PDU duplication; and
the transceiver and processor are further configured to transmit, to a WTRU, a PMF message indicating that PDU duplication is to be at least one of suspended or resumed.

37. A method for use in a device supporting access traffic steering, switching, and splitting (ATSSS), the method comprising:
receiving information to establish a multi-access protocol data unit (PDU) session, including first indication information for first ATSSS rules for a first redundant steering mode (RSM);
based on the first ATSSS rules for the first RSM:
duplicating a first PDU, and
transmitting the duplicated first PDU on both a first access network and a second access network;
receiving information to modify the PDU session, including second indication information for second ATSSS rules for a second RSM, wherein the second indication information for second ATSSS rules for the second RSM includes configured thresholds; and
based on the second ATSSS rules for the second RSM:
measuring performance metrics for the first access network;
measuring performance metrics for the second access network; and
on a condition that the measured performance metrics for both the first access network and the second access network do not satisfy the configured thresholds:
duplicating a second PDU; and
transmitting the duplicated second PDU on both the first access network and the second access network.

38. The method of claim 37, further comprising:
on a condition that the measured performance metrics for the first access network satisfy the configured thresholds and the measured performance metrics for the second access network do not satisfy the configured thresholds:
selecting the first access network; and
transmitting the second PDU on the selected first access network.

39. The method of claim 37, further comprising:
on a condition that the measured performance metrics for the second access network satisfy the configured thresholds and the measured performance metrics for the first access network do not satisfy the configured thresholds:
selecting the second access network; and
transmitting the second PDU on the selected second access network.

40. The method of claim 37, further comprising:
selecting an access network on a condition that the measured performance metrics for both the first access network and the second access network satisfy the configured thresholds; and
transmitting the second PDU on the selected access network.

41. The method of claim 40, wherein the selected access network is one of the first access network or the second access network.

42. The method of claim 41, wherein the selected access network is an initial access network included in the second ATSSS rules for the second RSM.

43. The method of claim 37, wherein the first RSM is static and the second RSM is dynamic.

44. The method of claim 37, wherein the first ATSSS rules for the first RSM do not include configured thresholds.

45. The method of claim 37, wherein the device is a wireless transmit/receive unit (WTRU); and further comprising:
receiving, from an access and mobility management function (AMF) during a registration procedure, third information indicating that ATSSS is supported;
transmitting, to the AMF, fourth information indicating (i) a request to establish a multi-access PDU session and (ii) RSM capabilities of the WTRU; wherein the received information to establish a multi-access PDU session is included in a response to the transmitted request;
receiving, from a user plane function (UPF), a performance management function (PMF) message; and
at least one of suspending PDU duplication based on the received PMF message or resuming PDU duplication based on the received PMF message.

46. The method of claim 37, wherein the device is a UPF; and further comprising:
determining to at least one of suspend PDU duplication or resume PDU duplication; and
transmit, to a WTRU, a PMF message indicating that PDU duplication is to be at least one of suspended or resumed.
